(19) United States
(12) Patent Application Publication
(10) Pub. No.: US 2006/0054269 A1
(43) Pub. Date: Mar. 16, 2006

(54) Method of manufacturing separator for fuel cell, and method of connecting the separator to electrode diffusion layer

(76) Inventors: Yoshitsugu Nishi, Saitama (JP); Kenichi Ishiguro, Saitama (JP)

Correspondence Address: RANKIN, HILL, PORTER & CLARK LLP, 4080 ERIE STREET, WILLOUGHBY, OH, 44094-7836, US

(21) Appl. No.: 10/517,013

(22) PCT Filed: Jul. 17, 2003
(86) PCT No.: PCT/JP03/09083

§ 371 Date: Jan. 11, 2005

(30) Foreign Application Priority Data
Jul. 18, 2002 (JP) 2002-209571
Jul. 18, 2002 (JP) 2002-29585
Aug. 23, 2002 (JP) 2002-244311

(51) Int. Cl. B32B 37/00

(52) U.S. Cl. 156/73.6; 156/272.2

(57) ABSTRACT

A method for manufacturing a fuel cell separator (18) for sandwiching from both sides via diffusion layers (15, 16) an anode (13) and a cathode (14) disposed on an electrolyte membrane (12). This manufacturing method includes mixing a thermoplastic resin (46) and a conductive material (45) to make a mixture (50), forming a separator starting material (68) with the mixture, and irradiating a contact face (20b, 30b) of this separator starting material with an electron beam (72), hardening the contact face of the separator. Even when reaction heat is produced in the fuel cell (10), elasticity of the separator contact face is ensured.

### TECHNICAL FIELD

This invention relates to a method for manufacturing separators for a fuel cell for sandwiching from both sides via diffusion layers an anode and a cathode disposed on an electrolyte membrane, and to a bonding method for bonding the separators to the electrode diffusion layers.

### BACKGROUND ART

A fuel cell is a cell which utilizes the opposite principle to the electrolysis of water to obtain electricity by the process of reacting hydrogen with oxygen to obtain water. Because generally a fuel gas is substituted for hydrogen and air or an oxidant gas is substituted for oxygen, the terms fuel gas, air and oxidant gas are often used. In the following, the basic construction of an ordinary fuel cell will be described with reference to FIG. 25, which shows one in exploded perspective view.

As shown in FIG. 25, a cell module of a fuel cell 200 is made by disposing an anode 202 and a cathode 203 on opposite faces of an electrolyte membrane 201 and sandwiching these electrodes 202, 203 with a first separator 206 and a second separator 207 via diffusion layers 204, 205. A fuel cell 200 is obtained by stacking many of these cell modules together.

It is necessary for the fuel gas to be brought into contact with the anode 202 effectively. To this end, many grooves (not shown) are provided in the face 206a of the first separator 206, and by the grooves being covered when the diffusion layer 204 is disposed on the face 206a, first flow passages (not shown) constituting fuel gas flow passages are formed.

On the other side, it is necessary for the oxidant gas to be brought into contact with the cathode 203 effectively. To this end, many grooves 208 . . . are provided in the face 207a of the second separator 207, and by the grooves 208 . . . being covered when the diffusion layer 205 is disposed on the face 207a of the second separator 207, second flow passages (not shown) constituting oxidant gas flow passages are formed.

And in the first separator 206, many cooling water passage grooves 209 . . . are provided in the reverse face 206b to the face 206a, and many cooling water passage grooves (not shown) are provided in the reverse face 207b to the face 207a in the second separator 207.

By the first and second separators 206, 207 being brought face to face, the cooling water passage grooves 209 . . . of each are brought together to form cooling water passages (not shown).

As a method of manufacturing these first and second separators 206 and 207, for example the “Fuel Cell Separator and Manufacturing Method Thereof” in Japanese Patent Publication JP-A-2001-126744 is known.

In this manufacturing method, conductive particles mixed with a thermoplastic resin are heated and kneaded; this heated and kneaded mixture is extrusion-molded and formed into a long sheet with rollers for rolling; this long sheet is cut to predetermined dimensions to make blanks; and first and second separators 206, 207 are obtained by forming gas passages and cooling water passage grooves in both sides or one side of these blanks.

To form the first and second flow passages by bringing the diffusion layers 204, 205 together with the first and second separators 206, 207 it is necessary for the diffusion layers 204, 205 to be brought together with the respective faces 206a, 207a of the first and second separators 206, 207 in an intimately contacting state.

However, because the first and second separators 206, 207 are molded with a thermoplastic resin, the respective faces 206a, 207a of the first and second separators 206, 207 are softened by reaction heat produced when the fuel cell is used.

Consequently, it is difficult to keep the respective faces 206a, 207a of the first and second separators 206, 207 and the diffusion layers 204, 205 in an intimately contacting state.

To resolve this problem, a seal material is applied between the respective faces 206a, 207a of the first and second separators 206, 207 and the diffusion layers 204, 205 to keep the respective faces 206a, 207a of the first and second separators 206, 207 and the diffusion layers 204, 205 in an intimately contacting state.

Similarly, a seal material is applied between the mating faces of the first separator 206 and the second separator 207 to keep the first separator 206 and the second separator 207 in an intimately contacting state. Consequently, seal materials for applying between the face 206a of the first separator and the diffusion layer 204 and between the face 207a of the second separator and the diffusion layer 205 are needed, and the number of parts increases. Also, there is the time and labor of applying seal materials between the face 206a of the first separator 206 and the diffusion layer 204 and between the face 207a of the second separator 207 and the diffusion layer 205, and this has been a hindrance to raising productivity.

As a fuel cell, for example the technology disclosed in Japanese Patent Publication JP-A-2000-123848, “Fuel Cell” is known. The main parts of this cell will now be described with reference to FIG. 26, which shows one in exploded perspective view.

As shown in FIG. 26, a cell module of a fuel cell 300 is formed by an anode 302 and a cathode 303 being placed against an electrolyte membrane 301 and these being sandwiched by a first separator 306 and a second separator 307 via gaskets 304, 305.

In more detail, the structure is such that first flow passages 308 to become fuel gas flow passages are formed in a face 306a of the first separator 306; second flow passages 309 to become oxidant gas flow passages are formed in a face 307a of the second separator 307; and the fuel gas and oxidant gas are each brought to face the electrolyte membrane 301 in the middle.

Because the electricity output obtained with one cell module is relatively small, many of these cell modules are stacked to obtain the required electricity output. Accordingly, the first and second separators 306, 307 are called “separators” because they are separating members for preventing fuel gas and oxidant gas from leaking into neighboring cells.

The first separator 306 has the flow passages 308 for fuel gas in its face 306a and the second separator 307 has the flow passages 309 for oxidant gas in its face 307a, and it is necessary for the gases to be brought into contact with the anode 302 and the cathode 303 effectively, and to this end it is necessary for many extremely shallow grooves to be provided as the flow passages 308, 309.

The first and second separators 306, 307 each have in a top part a fuel gas supply opening 310a and an oxidant gas supply opening 311a for supplying fuel gas and oxidant gas to the flow passages 308 and 309, each have in a bottom part a fuel gas discharge opening 310b and an oxidant gas discharge opening 311b, and each have a cooling water supply opening 312a in the top part and a cooling water discharge opening 312b in the bottom part for cooling water to pass through.

The fuel cell 300 described above normally has an anode diffusion layer (not shown) between the anode 302 and the first separator 306 and has a cathode diffusion layer (not shown) between the cathode 303 and the second separator 307.

To mate the anode diffusion layer with the first separator 306, for example a seal material (not shown) is interposed between the first separator 306 and the anode diffusion layer. And to mate the cathode diffusion layer with the second separator 307, for example a seal material (not shown) is interposed between the second separator 307 and the cathode diffusion layer.

Consequently, there is a risk of the electrical contact resistance between the first separator 306 and the anode diffusion layer increasing and the electrical contact resistance between the second separator 307 and the cathode diffusion layer increasing and the output of the fuel cell decreasing.

And, because it is necessary for a seal material to be interposed between the first separator 306 and the anode diffusion layer and for a seal material to be interposed between the second separator 307 and the cathode diffusion layer, this has been a hindrance to reducing the number of constituent parts.

Also, labor of assembling (for example, applying) the seal material between the first separator 306 and the anode diffusion layer and labor of assembling (for example, applying) the seal member between the second separator 307 and the cathode diffusion layer are necessary, and this has been a hindrance to reducing assembly labor.

The above-mentioned cooling water supply opening 312a and cooling water discharge opening 312b are connected to cooling water passages (not shown).

The cooling water passages are formed for example by forming cooling water passage grooves in the reverse side face to the face 306a of the first separator 306 and the reverse side face to the face 307a of the second separator 307 and bringing these cooling water passage grooves together with the cooling water passage grooves formed in separators of adjacent cells.

When the cooling water passages are formed by bringing first and second separators 306, 307 together like this, because the first and second separators 306, 307 are not integrated, there is a risk of the electrical contact resistance between the first and second separators 306, 307 increasing and the output of the fuel cell decreasing.

Also, when cooling water passages are formed by bringing first and second separators 306, 307 together, a seal material for preventing leakage of cooling water at the mating face of the first and second separators 306, 307 is necessary, and this has been a hindrance to reducing the number of constituent parts. Furthermore, labor of assembling (for example, applying) a seal material between the first and second separators 306, 307 is necessary, and this has been a hindrance to reducing assembly labor.

### DISCLOSURE OF THE INVENTION

In a first aspect, the present invention provides a method for manufacturing a fuel cell separator for sandwiching from both sides via diffusion layers an anode and a cathode disposed on an electrolyte membrane, the fuel cell manufacturing method being made up of: a step of obtaining a mixture by mixing a thermoplastic resin and a conductive material; a step of forming with this mixture a separator starting material having gas flow passage grooves in a contact face thereof to be in contact with the diffusion layer; and a step of irradiating the contact face of this separator starting material with an electron beam.

By molding a separator material with a thermoplastic resin and irradiating a contact face having gas flow passage grooves with an electron beam, it is possible to cause the contact face having the gas flow passage grooves to harden to some degree. Consequently, even when fuel cell reaction heat is produced, the elasticity of the contact face of the separator can be ensured and the contact face of the separator can be kept intimately in contact with the diffusion layer.

Therefore, because it is not necessary for a seal material to be applied between the contact face of the separator and the diffusion layer, the number of parts can be reduced and cost lowered. And because the time and labor of applying a seal material between the contact face of the separator and the diffusion layer can also be eliminated, productivity can be increased.

And because it is not necessary for a seal material to be applied between the contact face of the separator and the diffusion layer, the contact resistance between the contact face of the separator and the diffusion layer can be suppressed and the output of the fuel cell can be raised.

Also, with a simple step of just irradiating the contact face of the separator material with an electron beam, the contact face of the fuel cell separator can be transformed into an area with an excellent sealing property. As a result, fuel cell separators having an excellent sealing property can be produced efficiently, and the cost of separators can be reduced.

Preferably, the thermoplastic resin is made a resin selected from ethylene/vinyl acetate copolymers, ethylene/ethyl acrylate copolymers, straight-chain low-density polyethylene, polyphenylene sulfide and modified polyphenylene oxide, and the conductive material is made at least one type of carbon particle selected from black lead, Ketchen black and acetylene black.

Ethylene/vinyl acetate copolymers, ethylene/ethyl acrylate copolymers, straight-chain low-density polyethylene, polyphenylene sulfide and modified polyphenylene oxide are resins having superior pliability among thermoplastic resins, and by molding a separator with these resins it is possible to make the contact face of the separator contact the diffusion layer more intimately. As a result, the gap between the contact face of the separator and the diffusion layer can be sealed better.

Because black lead, Ketchen black and acetylene black have excellent conductivity, conductivity can be ensured with a relatively small quantity. As a result, the proportion included in the thermoplastic resin can be made relatively small, and its affect on the properties of the thermoplastic resin can be kept low.

In a second aspect, the invention provides a method for bonding a fuel cell separator and an electrode diffusion layer, made up of: disposing a carbon fiber electrode diffusion layer on a thermoplastic resin separator; applying a welding pressure to the electrode diffusion layer and separator; and vibrating either the electrode diffusion layer or the separator to produce frictional heat and thereby welding the electrode diffusion layer to the separator.

By integrating the thermoplastic resin separator and the electrode diffusion layer by welding them together with frictional heat, it is possible to suppress the electrical contact resistance between the separator and the electrode diffusion layer. And by integrating the thermoplastic resin separator and the electrode diffusion layer, it is possible to dispense with a seal material that has been needed in related art for mating the separator and the electrode diffusion layer. By dispensing with the seal material from between the separator and the electrode diffusion layer, it is possible to reduce the number of constituent parts. Also, it is possible to reduce the assembly labor of assembling (for example, applying) a seal material between the separator and the electrode diffusion layer. By reducing the number of constituent parts and reducing the assembly labor like this, it is possible to keep the cost of the separator down.

In a third aspect, the invention provides a method for manufacturing a fuel cell separator made up of: preparing a first separator made of thermoplastic resin and a second separator made of thermoplastic resin and provided with cooling water passage grooves in a face thereof to be bonded to the first separator; disposing the first separator on the second separator and then applying a welding pressure to the first and second separators; and vibrating one of the first and second separators to produce frictional heat and thereby welding the second separator to the first separator and covering the cooling water passage grooves with this first separator to form cooling water passages.

The first and second separators made of thermoplastic resin are integrated by welding with frictional heat and the cooling water passage grooves are covered with the first separator to form cooling water passages. By integrating the first and second separators by welding with frictional heat like this, it is possible to suppress electrical contact resistance between the first and second separators. And by integrating the first and second separators by welding with frictional heat it is possible to eliminate a seal material from between the first and second separators. By eliminating a seal material from between the first and second separators like this, it is possible to reduce the number of constituent parts. Also, it is possible to eliminate the assembly labor of assembling a seal material between the first and second separators. By reducing the number of constituent parts and reducing assembly labor like this, it is possible to keep down the cost of separators.

Preferably, the welding pressure is made 10 to 50 kgf/cm² (about 980 to 4903 kPa) and the frequency of the vibration is made 240 Hz.

The pressures in this invention are all gauge pressures.

With a welding pressure of below 10 kgf/cm², it is difficult to produce a sufficient frictional heat at the bonding faces of the first and second separators, and the first and second separators cannot be welded together. Accordingly, the welding pressure is set to above 10 kgf/cm² to weld the first and second separators together. When on the other hand the welding pressure exceeds 50 kgf/cm², a large frictional heat is produced at the bonding faces of the first and second separators, and the first and second separators melt excessively and burrs form at the edges of the first and second separators.

Consequently, an extra step of removing burrs formed at the edges of the first and second separators becomes necessary. Accordingly, the welding pressure is set to below 50 kgf/cm² to prevent burrs from forming at the edges of the first and second separators. As a result, because a burr removal operation can be eliminated, productivity can be raised.

### BRIEF DESCRIPTION OF THE DRAWINGS

FIG. 1 is an exploded perspective view showing a fuel cell with a fuel cell separator manufactured by a fuel cell separator manufacturing method according to a first embodiment of the invention;

FIG. 2 is a sectional view on the line A-A in FIG. 1;

FIG. 3 is a sectional view on the line B-B in FIG. 1;

FIG. 4 is a sectional view of the fuel cell separator of FIG. 1;

FIG. 5 is a flow chart of a fuel cell separator manufacturing method according to the first embodiment of the invention;

FIG. 6A and FIG. 6B are views illustrating a step of forming a mixture into pellets in the manufacturing method;

FIG. 7 is a view illustrating a pressing step in the manufacturing method;

FIG. 8 is a view illustrating a step of electron beam irradiation in the manufacturing method;

FIG. 9 is an exploded perspective view of a fuel cell in which a fuel cell separator and an electrode diffusion layer are bonded by a bonding method according to a second embodiment of the invention;

FIG. 10 is a sectional view on the line C-C in FIG. 9;

FIG. 11 is a sectional view of a vibration-welding apparatus for carrying out a bonding method according to the second embodiment of the invention;

FIG. 12A and FIG. 12B are views illustrating a step of setting a first separator and an anode diffusion layer in a bonding method according to the second embodiment of the invention;

FIG. 13A and FIG. 13B are views illustrating a step of applying a welding pressure to the first separator and the anode diffusion layer in a bonding method according to the second embodiment of the invention;

FIG. 14A and FIG. 14B are views illustrating a step of vibration-welding the anode diffusion layer to the first separator in a bonding method according to the second embodiment of the invention;

FIG. 15 is a view illustrating a step of removing the vibration-welded first separator and the anode diffusion layer in a bonding method according to the second embodiment of the invention;

FIG. 16A and FIG. 16B are views illustrating a step of setting a second separator and a cathode diffusion layer in a bonding method according to the second embodiment of the invention;

FIG. 17A and FIG. 17B are views illustrating a step of vibration-welding the cathode diffusion layer to the second separator in a bonding method according to the second embodiment of the invention;

FIG. 18A and FIG. 18B are views illustrating an example of setting a separator obtained by a bonding method according to the second embodiment of the invention;

FIG. 19A and FIG. 19B are views illustrating an example of vibration-welding separators obtained by a bonding method according to the second embodiment of the invention together;

FIG. 20 is a sectional view showing a fuel cell separator obtained by a fuel cell separator manufacturing method according to a third embodiment of the invention;

FIG. 21A and FIG. 21B are views illustrating a step of setting first and second separators in a manufacturing method according to the third embodiment of the invention;

FIG. 22A and FIG. 22B are views illustrating a step of applying a welding pressure to first and second separators in a manufacturing method according to the third embodiment of the invention;

FIG. 23A and FIG. 23B are views illustrating a step of vibration-welding first and second separators in a manufacturing method according to the third embodiment of the invention;

FIG. 24 is a view illustrating a step of removing vibration-welded first and second separators in a manufacturing method according to the third embodiment of the invention;

FIG. 25 is an exploded perspective view showing a fuel cell of related art; and

FIG. 26 is an exploded perspective view of another fuel cell of related art.

### BEST MODES FOR CARRYING OUT THE INVENTION

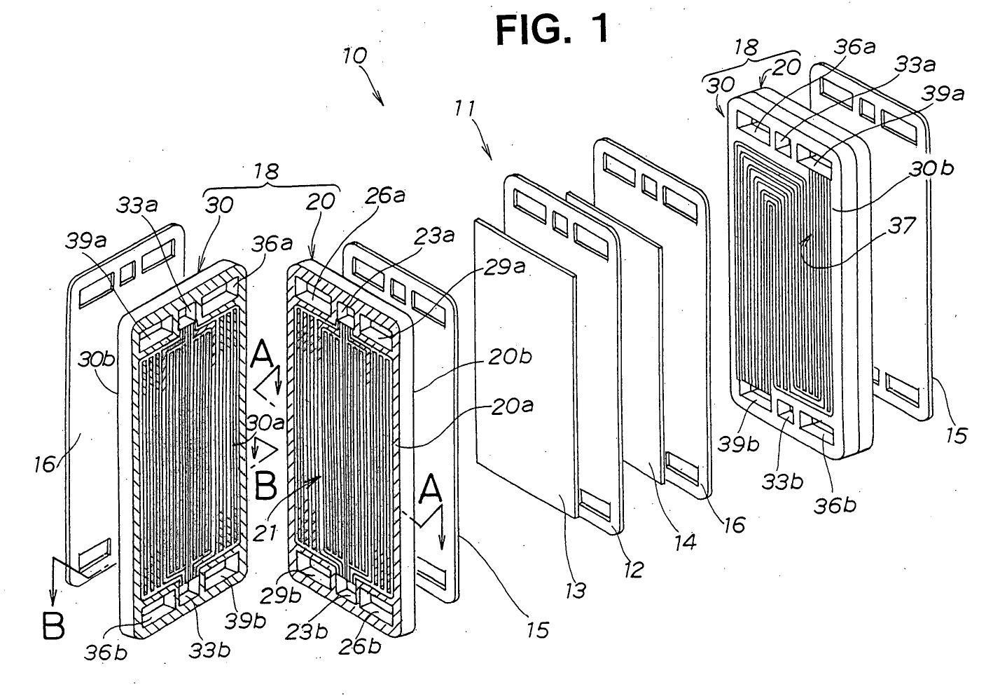

As shown in FIG. 1, a fuel cell 10 is a solid polymer type fuel cell made by constructing cell modules 11 by using for example a solid polymer electrolyte as an electrolyte membrane 12, appending an anode 13 and a cathode 14 to this electrolyte membrane 12, disposing a separator 18 on the anode 13 side via an anode diffusion layer 15 and disposing a separator (fuel cell separator) 18 on the cathode 14 via a cathode diffusion layer 16, and stacking many of these cell modules 11 together.

The separator 18 is made up of a first separator 20 and a second separator 30, and has a cooling water passage formation face 20a of the first separator 20 and a bonding face 30a of the second separator 30 bonded together by for example vibration welding.

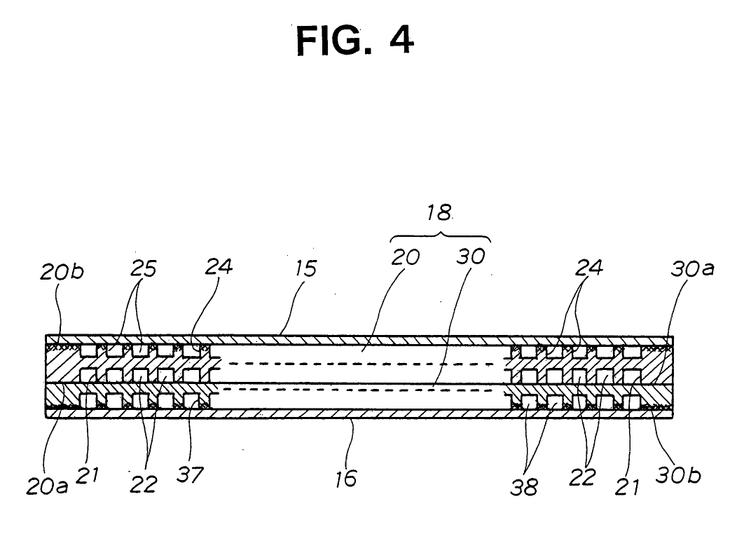

By the first and second separators 20, 30 being vibration-welded together like this, cooling water passage grooves 21 . . . in the first separator 20 are covered by the second separator 30 and form cooling water passages 22 . . . (see FIG. 4).

Cooling water supply openings 23a, 33a in the centers of the top ends of the first and second separators 20, 30 and cooling water discharge openings 23b, 33b in the centers of the bottom ends of the first and second separators 20, 30 connect with these cooling water passages 22 . . .

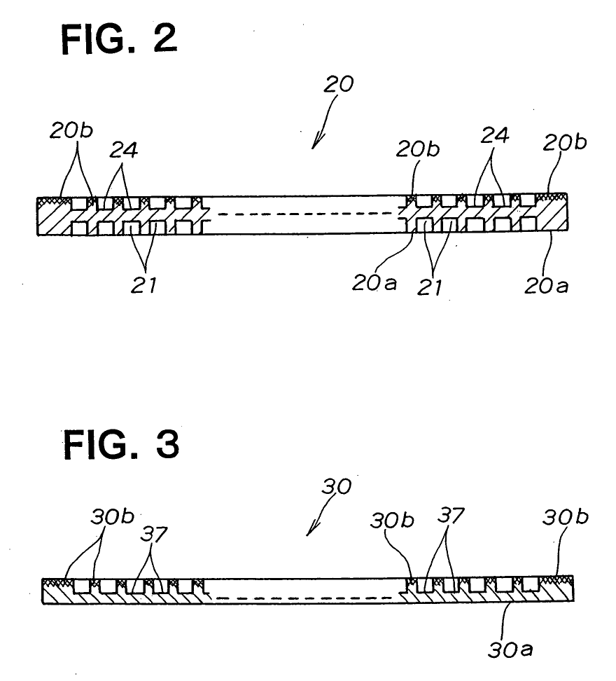

The first separator 20 has fuel gas passage grooves 24 . . . (see FIG. 2) on a fuel gas passage formation face (contact face) 20b, and by the anode diffusion layer 15 being placed on the fuel gas passage formation face 20b the anode diffusion layer 15 covers the fuel gas passage grooves 24 . . . and forms fuel gas passages 25 . . . (see FIG. 4).

Fuel gas supply openings 26a, 36a in the left sides of the top ends of the first and second separators 20, 30 and fuel gas discharge openings 26b, 36b in the right sides of the bottom ends of the first and second separators 20, 30 are connected to these fuel gas passages 25 . . .

The second separator 30 has oxidant gas passage grooves 37 . . . in an oxidant gas passage formation face (contact face) 30b, and by the cathode diffusion layer 16 being placed on the oxidant gas passage formation face 30b the cathode diffusion layer 16 covers the oxidant gas passage grooves 37 . . . and forms oxidant gas passages 38 . . . (see FIG. 4).

Oxidant gas supply openings 29a, 39a in the right sides of the top ends of the first and second separators 20, 30 and oxidant gas discharge openings 29b, 39b in the left sides of the bottom ends of the first and second separators 20, 30 are connected to the oxidant gas passages 38 . . .

Next, referring to FIG. 2, the first separator 20 is a member formed in a substantially rectangular shape (see FIG. 1) with a resin made by mixing a conductive material with a thermoplastic resin, and has many cooling water passage grooves 21 . . . in a cooling water passage formation face 20a and has many fuel gas passage grooves 24 . . . in the fuel gas passage formation face 20b.

As the thermoplastic resin, for example ethylene/vinyl acetate copolymers, ethylene/ethyl acrylate copolymers, straight-chain low-density polyethylene, polyphenylene sulfide and modified polyphenylene oxide are suitable, but the invention is not limited to these.

As the conductive material (carbon material), a carbon particle selected from at least one type among Ketchen black, black lead and acetylene black is suitable, but the invention is not limited to this.

Ketchen black is a carbon black having superior conductivity, and for example that made by Ketchen Black International Co., Ltd. (sold by Mitsubishi Chemical Co., Ltd.) is suitable, although the invention is not limited to this.

Ethylene/vinyl acetate copolymers, ethylene/ethyl acrylate copolymers, straight-chain low-density polyethylene, polyphenylene sulfide and modified polyphenylene oxide are resins having pliability among thermoplastic resins, and by using these resins it is possible to make the first separator 20 a member having superior pliability.

Also, by being irradiated with an electron beam, the fuel gas passage formation face 20b is somewhat hardened and made a face having a 3-dimensional bridge structure.

By the first separator 20 being made a member having superior pliability and the fuel gas passage formation face 20b being irradiated with an electron beam like this, the fuel gas passage formation face 20b can be made a face having superior elasticity.

And, Ketchen black, black lead and acetylene black are materials having superior conductivity, and by a carbon particle selected from at least one type among Ketchen black, black lead and acetylene black being used as the conductive material (carbon material), conductivity of the first separator 20 can be ensured with a relatively small quantity.

Because consequently the proportion included in the thermoplastic resin can be made relatively small, the moldability of the thermoplastic resin can be maintained and the first separator 20 can be molded easily.

As shown in FIG. 3, the second separator 30, like the first separator 20, is a member formed in a substantially rectangular shape (see FIG. 1) with a resin made by mixing a conductive material with a thermoplastic resin, and has a bonding face 30a formed flat and has many oxidant gas passage grooves 37 . . . in an oxidant gas passage formation face 30b.

As the thermoplastic resin, for example ethylene/vinyl acetate copolymers, ethylene/ethyl acrylate copolymers, straight-chain low-density polyethylene, polyphenylene sulfide and modified polyphenylene oxide are suitable, but the invention is not limited to these.

As the conductive material (carbon material), a carbon particle selected from at least one type among Ketchen black, black lead and acetylene black is suitable, but the invention is not limited to this.

Ethylene/vinyl acetate copolymers, ethylene/ethyl acrylate copolymers, straight-chain low-density polyethylene, polyphenylene sulfide and modified polyphenylene oxide are resins having pliability among thermoplastic resins, and by using these resins it is possible to make the second separator 30 a member having superior pliability.

Also, by being irradiated with an electron beam, the oxidant gas passage formation face 30b is somewhat hardened and made a face having a 3-dimensional bridge structure.

By the second separator 30 being made a member having superior pliability and the oxidant gas passage formation face 30b being irradiated with an electron beam like this, the oxidant gas passage formation face 30b can be made a face having superior elasticity.

And, Ketchen black, black lead and acetylene black are materials having superior conductivity, and by a carbon particle selected from at least one type among Ketchen black, black lead and acetylene black being used as the conductive material (carbon material), conductivity of the second separator 30 can be ensured with a relatively small quantity.

Because consequently the proportion included in the thermoplastic resin can be made relatively small, the moldability of the thermoplastic resin can be maintained and the second separator 30 can be molded easily.

Next, reference will be made to FIG. 4, which shows the electrode diffusion layers 15, 16 stacked with the separator 18.

The separator 18 is made by bringing together the first and second separators 20, 30 and then applying a welding pressure to the first and second separators 20, 30 and vibrating one or the other of the first and second separators 20, 30 to produce frictional heat, thereby vibration-welding the cooling water passage formation face 20a of the first separator 20 and the bonding face 30a of the second separator 30 together and covering the cooling water passage grooves 21 of the first separator 20 with the second separator 30 and forming cooling water passages 22.

The bonding of the first and second separators 20, 30 is not limited to vibration-welding, and they can alternatively be bonded by some other method.

By the anode diffusion layer 15 being brought together with the fuel gas passage formation face 20b, fuel gas passages 25 . . . are formed by the fuel gas passage grooves 24 . . . and the anode diffusion layer 15.

By the first separator 20 being made of a resin having superior pliability and the fuel gas passage formation face 20b being irradiated with an electron beam, the fuel gas passage formation face 20b is somewhat hardened and a 3-dimensional bridge structure is obtained by a bridging reaction being promoted.

As a result of the fuel gas passage formation face 20b being made a 3-dimensional bridge structure like this, polymer chains connect together at arbitrary positions other than at their ends, and the heat resistance and rigidity of the fuel gas passage formation face 20b can be raised.

Because by this means elasticity of the fuel gas passage formation face 20b is ensured when reaction heat of the fuel cell is produced, the fuel gas passage formation face 20b can be kept intimately in contact with the anode diffusion layer 15.

Consequently, it is not necessary for a seal material to be applied between the fuel gas passage formation face 20b and the anode diffusion layer 15. Therefore, the number of parts can be reduced and the time and labor of applying a seal material can be eliminated, and also the contact resistance between the fuel gas passage formation face 20b and the anode diffusion layer 15 can be suppressed and the output of the fuel cell raised.

And, as a result of the cathode diffusion layer 16 being brought together with the oxidant gas passage formation face 30b, by the oxidant gas passage grooves 37 . . . and the cathode diffusion layer 16 the oxidant gas passages 38 . . . are formed.

By the second separator 30 being formed with a resin having superior pliability and the oxidant gas passage formation face 30b being irradiated with an electron beam, the oxidant gas passage formation face 30b is somewhat hardened and given a 3-dimensional bridge structure. And because by this means it is possible to ensure elasticity of the oxidant gas passage formation face 30b when reaction heat of the fuel cell is produced, the oxidant gas passage formation face 30b can be kept intimately in contact with the cathode diffusion layer 16.

Consequently, it is not necessary for a seal material to be applied between the oxidant gas passage formation face 30b and the cathode diffusion layer 16. Therefore, the number of parts can be reduced and the time and labor of applying a seal material can be eliminated, and also the contact resistance between the oxidant gas passage formation face 30b and the cathode diffusion layer 16 can be suppressed and the output of the fuel cell raised.

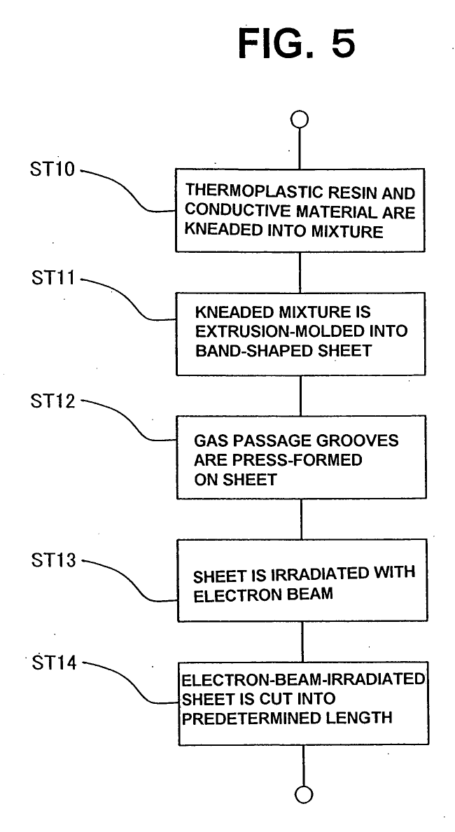

Next, an example of molding a first separator 20 by a fuel cell separator manufacturing method according to the invention (first embodiment) will be described, on the basis of FIG. 5 through FIG. 8.

FIG. 5 is a flow chart of a fuel cell separator manufacturing method according to a first embodiment of the invention. In the figure, STxx denotes step number.

ST10: A mixture is obtained by kneading together a thermoplastic resin and a conductive material.

ST11: A band-shaped sheet is formed by extrusion-molding the kneaded mixture.

ST12: In one side of this band-shaped sheet, that is, the side corresponding to the cooling water passage formation face, cooling water passage grooves are press-formed, and in the other side of the band-shaped sheet, that is, the side corresponding to the fuel gas passage formation face, fuel gas passage grooves are press-formed, and a separator starting material is thereby obtained.

ST13: The side on which the fuel gas passage grooves were press-formed is irradiated with an electron beam.

ST14: First separators are obtained by cutting the separator starting material to a predetermined dimension.

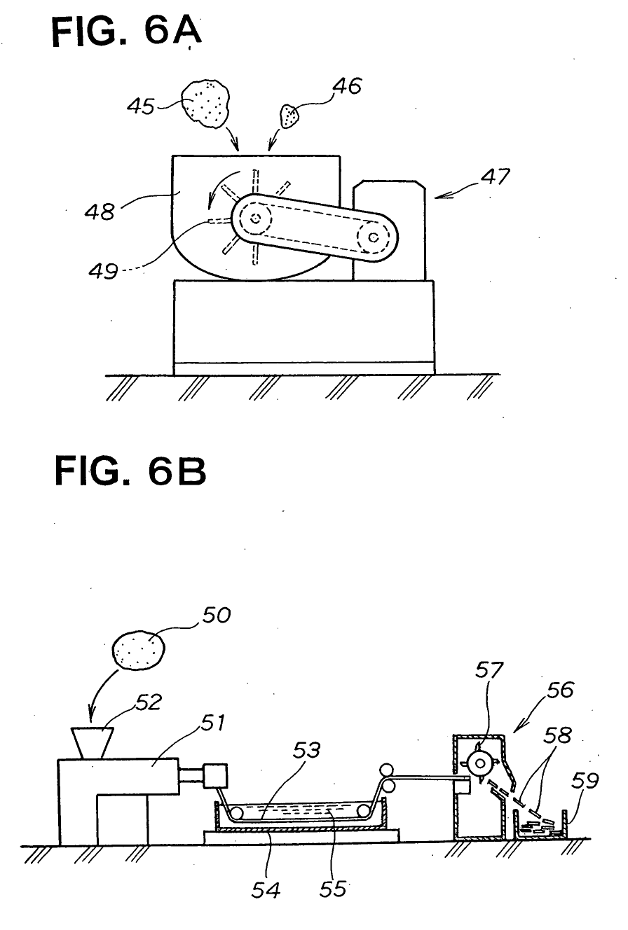

ST10 to ST14 of the manufacturing method described above will now be explained in detail with reference to FIG. 6A through FIG. 8.

FIG. 6A and FIG. 6B are views illustrating a step of forming a mixture into pellets in a manufacturing method according to the first embodiment of the invention. Specifically, FIG. 6A shows ST10 and FIG. 6B shows the first half of ST11.

In FIG. 6A, first, a thermoplastic resin 46 selected from ethylene/vinyl acetate copolymers, ethylene/ethyl acrylate copolymers, straight-chain low-density polyethylene, poly-phenylene sulfide and modified polyphenylene oxide is prepared.

Then, a conductive material 45 of at least one type selected from among black lead, Ketchen black, and acetylene black carbon particles is prepared.

The thermoplastic resin 46 and the conductive material 45 prepared are fed into a vessel 48 of a kneading machine 47 as shown with arrows. The thermoplastic resin 46 and the conductive material 45 fed in are kneaded inside the vessel 48 by kneading vanes (or a screw) 49 being rotated as shown with an arrow.

In FIG. 6B, the mixture 50 formed by kneading the thermo-plastic resin 46 and the conductive material 45 is fed into a hopper 52 of a first extrusion-molding machine 51 and the mixture 50 fed in is extrusion-molded by the first extrusion-molding machine 51. By the extrusion-molded molding 53 being passed through a water tank 54, the molding 53 is cooled by water 55 in the water tank 54.

The cooled molding 53 is cut to a predetermined length with a cutter 57 of a cutting machine 56, and the cut pellets 58 . . . are stocked in a stock tray 59.

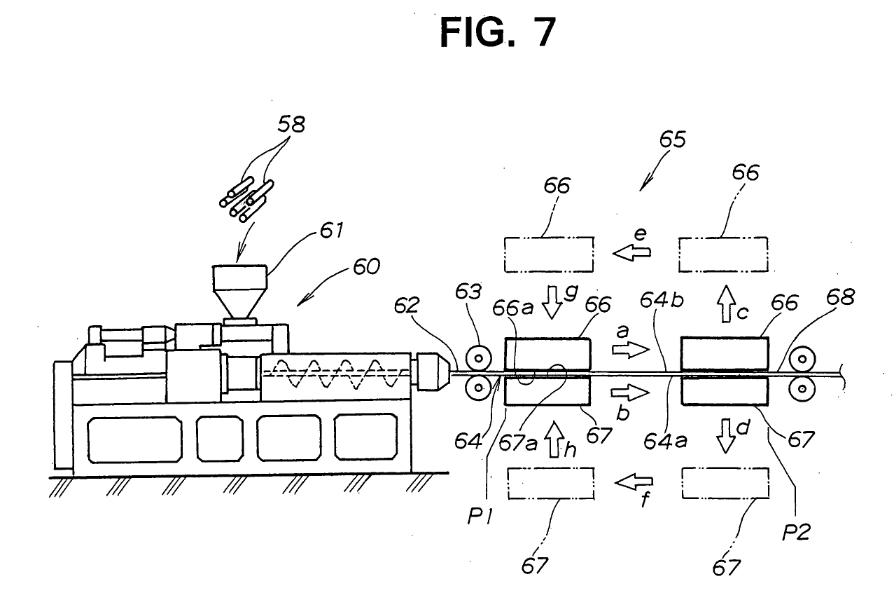

FIG. 7 is a view illustrating a pressing step in the above manufacturing method, and specifically shows the latter half of ST11 to ST12.

The pellets 58 . . . obtained in the previous step are fed into a hopper 61 of a second extrusion-molding machine 60 as shown with an arrow, and the fed pellets 58 . . . are extrusion-molded by the second extrusion-molding machine 60. A extrusion-molded moldings 62 thus extrusion-molded are rolled with rollers 63 to form a band-shaped sheet 64.

A pressing machine 65 is provided on the downstream side of the rollers 63, and this pressing machine 65 has upper and lower press dies 66, 67 above and below the sheet 64 respectively.

The upper press die 66 has tongues and grooves (not shown) in a press face 66a facing a second side 64b of the band-shaped sheet 64. These tongues and grooves are for press-forming the fuel gas passage grooves 24 . . . (see FIG. 4) in the second side 64b of the band-shaped sheet 64.

The lower press die 67 has tongues and grooves (not shown) in a press face 67a facing a first side 64a of the band-shaped sheet 64. These tongues and grooves are for press-forming the cooling water passage grooves 21 . . . in the first side 64a of the band-shaped sheet 64.

The upper and lower press dies 66, 67 are disposed at a press starting position P1, both sides 64a, 64b of the band-shaped sheet 64 are pressed with the upper and lower press dies 66, 67, and with this state being maintained the upper and lower press dies 66, 67 are moved as shown by the arrows a, b at the extrusion speed of the band-shaped sheet 64. In this way, cooling water passage grooves 21 . . . are press-formed in the first side 64a of the band-shaped sheet 64, i.e. the side corresponding to the cooling water passage formation face 20a (see FIG. 4), and fuel gas passage grooves 24 . . . are press-formed in the second side 64b of the band-shaped sheet 64, i.e. the side corresponding to the fuel gas passage formation face 20b (see FIG. 4), whereby the band-shaped sheet 64 is formed into a separator starting material 68.

When the upper and lower press dies 66, 67 reach a press releasing position P2, the upper and lower press dies 66, 67 move away from the band-shaped sheet 64 as shown by the arrows c and d, and after the upper and lower press dies 66, 67 have reached a predetermined release-side position, the upper and lower press dies 66, 67 move toward the upstream side as shown by the arrows e and f. When the upper and lower press dies 66, 67 have reached a predetermined press start-side position, the upper and lower press dies 66, 67 are moved to the press start position P1 as shown by the arrows g and h.

By the steps described above being repeated in turn, the cooling water passage grooves 21 . . . and fuel gas passage grooves 24 . . . shown in FIG. 4 are press-formed in the sides 64a, 64b of the band-shaped sheet 64.

In FIG. 7, to facilitate understanding, an example was illustrated wherein one each of the upper and lower press dies 66, 67 were provided; however, in practice a plurality of each of the upper and lower press dies 66, 67 are provided.

By a plurality of each of the upper and lower press dies 66, 67 being provided, cooling water passage grooves 21 . . . and fuel gas passage grooves 24 . . . (see FIG. 4) can be press-formed continuously in the sides 64a, 64b of the band-shaped sheet 64.

The upper and lower press dies 66, 67 have parts for forming the fuel gas supply opening 26a and the fuel gas discharge opening 26b shown in FIG. 1. And, the upper and lower press dies 66, 67 have parts for forming the oxidant gas supply opening 29a and the oxidant gas discharge opening 29b shown in FIG. 1.

Also, the upper and lower press dies 66, 67 have parts for forming the cooling water supply opening 23a and the cooling water discharge opening 23b shown in FIG. 1.

Thus, as well as the cooling water passage grooves 21 . . . and the fuel gas passage grooves 24 . . . shown in FIG. 4 respectively being press-formed continuously in the sides 64a, 64b of the band-shaped sheet 64 with the upper and lower press dies 66 and 67, the cooling water supply opening 23a and the gas supply openings 26a, 29a and the cooling water discharge opening 23b and the gas discharge openings 26b, 29b are formed at the same time.

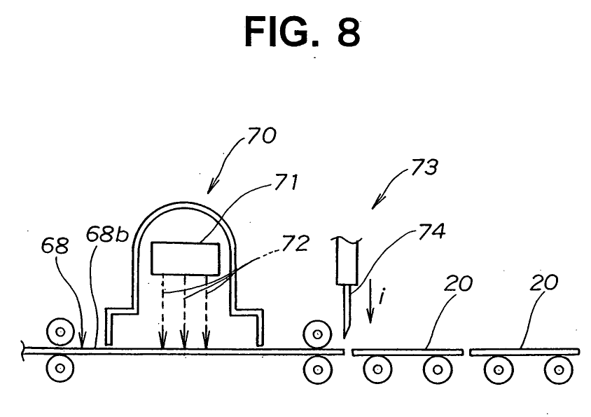

FIG. 8 is a view illustrating the electron beam irradiation step and the sheet cutting step of the first embodiment, and specifically shows ST13 and ST14.

On the downstream side of the pressing machine 65 (see FIG. 7), an electron beam irradiating apparatus 70 is provided above the separator starting material 68 obtained in the previous step, that is, above the second side 68b with the fuel gas passage grooves 24 . . . press-formed in it (see FIG. 4).

An electron beam 72 is radiated from an electron gun 71 of this electron beam irradiating apparatus 70. With this electron beam 72, the top of the second side 68b with the fuel gas passage grooves 24 . . . press-formed in it is irradiated. By this means, the second side 68b with the fuel gas passage grooves 24 . . . press-formed in it is somewhat hardened and is made a 3-dimensional bridge structure.

A cutter device 73 is provided above the separator starting material 68 obtained in the previous step, on the downstream side of the electron beam irradiating apparatus 70. By a cutter 74 of this cutter device 73 being lowered as shown by the arrow i, the separator starting material 68 is cut to a predetermined dimension and first separators 20 . . . are obtained. This ends the process of manufacturing the first separator 20.

Thus, with a fuel cell separator manufacturing method according to the invention, by the simple method of just irradiating it with an electron beam 72, the fuel gas passage formation face 20b (see FIG. 4) can be somewhat hardened and made a 3-dimensional bridge structure.

Therefore, it is possible to keep the elasticity of the fuel gas passage formation face 20b good and its sealing property can be kept good. Because of this, it is possible to produce first separators 20 having an excellent sealing property with good efficiency.

And, ethylene/vinyl acetate copolymers, ethylene/ethyl acrylate copolymers, straight-chain low-density polyethylene, polyphenylene sulfide and modified polyphenylene oxide are resins having particularly good pliability among thermoplastic resins, and by the first separator 20 being made of such a resin 45, the pliability of the fuel gas passage formation face 20b (see FIG. 4) of the first separator 20 can be guaranteed well.

Although a method for manufacturing a first separator 20 has been described in connection with FIG. 5 through FIG. 8, the second separator 30 may also be manufactured by the same method. However, because the second separator 30 does not have the cooling water passage grooves 21 . . . like the first separator 20, and has a flat bonding face 30a, the lower press die 67 shown in FIG. 7 does not need to have tongues and grooves for press-forming cooling water passage grooves 21 . . . in the first side of the band-shaped sheet 64 in its face facing the first side of the band-shaped sheet 64.

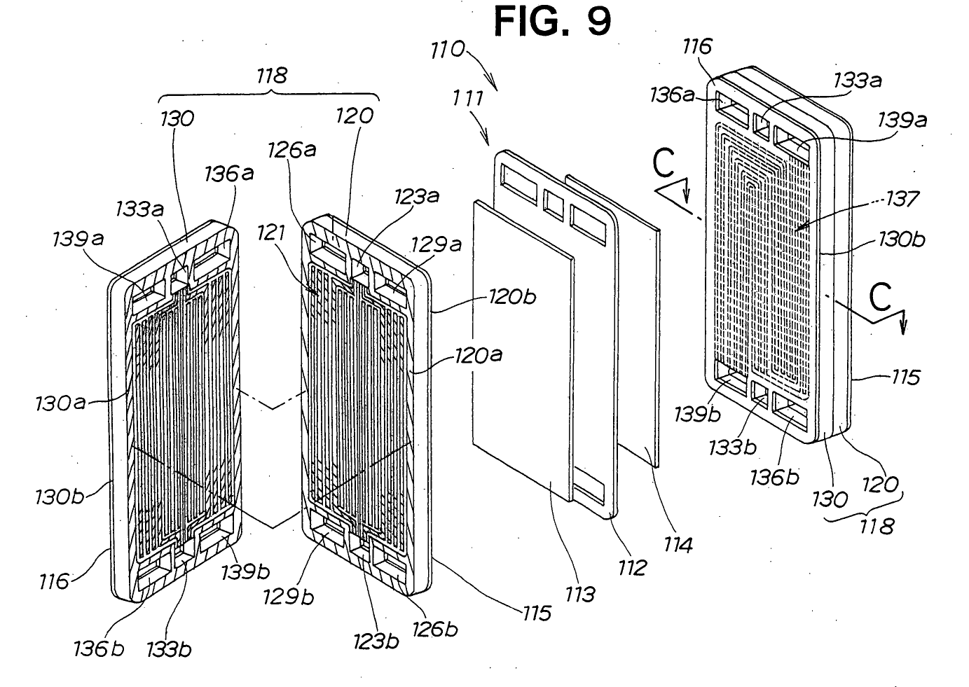

Next, second and third embodiments of the invention will be described, on the basis of FIG. 9 through FIG. 24.

In the second and third embodiments, parts the same as parts in the first embodiment have been given the same reference numerals and will not be described again.

First, reference will be made to FIG. 9, which shows in exploded perspective view a fuel cell having a fuel cell separator and an electrode diffusion layer bonded by a bonding method according to a second embodiment of the invention.

As shown in FIG. 9, a fuel cell 110 is a solid polymer type fuel cell made by constructing cell modules 111 by using for example a solid polymer electrolyte as an electrolyte membrane 112, appending an anode 113 and a cathode 114 to this electrolyte membrane 112, disposing a separator 118 on the anode 113 side via an anode diffusion layer 115 and disposing a separator 118 on the cathode 114 side via a cathode diffusion layer 116, and stacking many of these cell modules 111 together.

The separator 118 is made up of a first separator 120 and a second separator 130, and a cooling water passage formation face 120a of the first separator 120 and a bonding face 130a of the second separator 130 are for example bonded by vibration-welding.

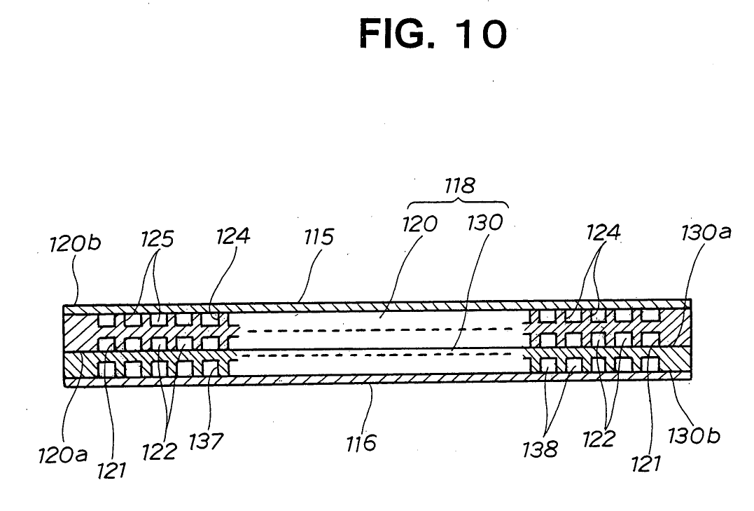

By the first and second separators 120, 130 being vibration-welded together like this, cooling water passage grooves 121 . . . in the first separator 120 are covered by the second separator 130 to form cooling water passages 122 . . . (see FIG. 10).

Cooling water supply openings 123a, 133a in the centers of the top ends of the first and second separators 120, 130 and cooling water discharge openings 123b, 133b in the centers of the bottom ends of the first and second separators 120, 130 connect with these cooling water passages 122 . . .

The first separator 120 has fuel gas passage grooves 124 . . . (see FIG. 10) on a fuel gas passage formation face 120b side, and by the anode diffusion layer 115 being brought together with the fuel gas passage formation face 120b and for example vibration-welded the fuel gas passage grooves 124 . . . are covered with the anode diffusion layer 115 and fuel gas passages 125 . . . (see FIG. 10) are formed.

Fuel gas supply openings 126a, 136a in the left sides of the top ends of the first and second separators 120, 130 and fuel gas discharge openings 126b, 136b in the right sides of the bottom ends of the first and second separators 120, 130 are connected to these fuel gas passages 125 . . .

The second separator 130 has oxidant gas passage grooves 137 . . . in an oxidant gas passage formation face 130b side, and by the cathode diffusion layer 116 being brought together with the oxidant gas passage formation face 130b and for example vibration-welded the oxidant gas passage grooves 137 . . . are covered by the cathode diffusion layer 116 and oxidant gas passages 138 . . . (see FIG. 10) are formed.

Oxidant gas supply openings 129a, 139a in the right sides of the top ends of the first and second separators 120, 130 and oxidant gas discharge openings 129b, 139b in the left sides of the bottom ends of the first and second separators 120, 130 are connected to these oxidant gas passages 138 . . .

As the resin constituting the first and second separators 120, 130, for example a resin composition including 60 to 95 wt % of carbon material made by blending natural lead, artificial lead, Ketchen black or acetylene black or the like individually or in a mixture with a thermoplastic resin having resistance to oxidation is suitable, although the invention is not limited to this.

Ketchen black is a carbon black having superior conductivity, and for example that made by Ketchen Black International Co., Ltd. (sold by Mitsubishi Chemical Co., Ltd.) is suitable, although the invention is not limited to this.

The first and second separators 120, 130 are carbon mold separators made by molding the above-mentioned resin composition by injection-molding, thermal press-forming or roll-forming.

As the thermoplastic resin having resistance to oxidation, for example ethylene/vinyl acetate copolymers, ethylene/ethyl acrylate copolymers, straight-chain low-density polyethylene, polyphenylene sulfide and modified polyphenylene oxide are suitable, although the invention is not limited to these.

As the anode diffusion layer 115, for example carbon fiber of carbon woven cloth, carbon nonwoven cloth, carbon mat, or carbon paper is suitable, although the invention is not limited to this.

As the cathode diffusion layer 116, like the anode diffusion layer 115, for example carbon fiber of carbon woven cloth, carbon nonwoven cloth, carbon mat, or carbon paper is suitable, but the invention is not limited to this.

Referring to FIG. 10, the first separator 120 is a member formed in a substantially rectangular shape, as is clear from FIG. 9, and has many fuel gas passage grooves 124 . . . in a fuel gas passage formation face 120b, and by the anode diffusion layer 115 being vibration-welded to this fuel gas passage formation face 120b fuel gas passages 125 . . . is formed with the fuel gas passage grooves 124 . . . and the anode diffusion layer 115, and it has many cooling water passage grooves 121 . . . in the cooling water passage formation face 120a.

The second separator 130 also, as is clear from FIG. 9, is a substantially rectangular member having many oxidant gas passage grooves 137 . . . in an oxidant gas passage formation face 130b, and by the cathode diffusion layer 116 being vibration-welded to this oxidant gas passage formation face 130b the oxidant gas passages 138 . . . are formed by the oxidant gas passage grooves 137 . . . and the cathode diffusion layer 116.

The separator 118 has cooling water passages 122 formed by the cooling water passage formation face 120a of the first separator 120 and the bonding face 130a of the second separator 130 being vibration-welded together and the cooling water passage grooves 121 in the first separator 120 being covered by the bonding face 130a of the second separator 130.

By integrating the thermoplastic resin first separator 120 and the anode diffusion layer 115 by vibration-welding like this it is possible to suppress the electrical contact resistance between the first separator 120 and the anode diffusion layer 115. And, by integrating the thermoplastic resin first separator 120 and the anode diffusion layer 115, it is possible to dispense with the seal material that has been necessary in related art to join the first separator 120 and the anode diffusion layer 115.

Similarly, by integrating the thermoplastic resin second separator 130 and the cathode diffusion layer 116 by vibration-welding it is possible to suppress the electrical contact resistance between the second separator 130 and the cathode diffusion layer 116. And, by integrating the thermoplastic resin second separator 130 and the cathode diffusion layer 116 it is possible to dispense with the seal material that has been necessary in related art to join the second separator 130 and the cathode diffusion layer 116.

Also, the separator 118 is integrated by vibration-welding together the first and second thermoplastic resin separators 120 and 130, and cooling water passages 122 are formed by the cooling water passage grooves 121 in the first separator 120 being covered by the bonding face 130a of the second separator 130.

By integrating the separator 118 by vibration-welding the first and second separators 120, 130 together like this, it is possible to suppress the electrical contact resistance between the first and second separators 120, 130. And, by integrating the separator 118 by vibration-welding the first and second separators 120, 130 together, it is possible to dispense with the seal material that has been necessary in related art from between the first and second separators 120, 130.

Next, reference will be made to FIG. 11, which shows in cross-section a vibration-welding apparatus for implementing a method for bonding a fuel cell separator and an electrode diffusion layer according to the second embodiment of the invention.

A vibration-welding apparatus 140 has left and right pillars 142, 142 standing at a predetermined spacing on a bed 141, the upper ends of the left and right pillars 142, 142 being connected to left and right beams 143, 143; an ascending/descending member 145 ascend/descendably attached to the left and right pillars 142, 142 by guides 144, 144; an air cylinder 146 disposed between the ascending/descending member 145 and the bed 141; a cylinder part 147 connected to the bed 141; a piston rod 148 connected to the ascending/descending member 145; a lower support part 149 connected to the ascending/descending member 145; a vibrating mechanism 150 attached to the left and right beams 143; and an upper support part 151 mounted on the bottom of the vibrating mechanism 150 so as to face the lower support part 149.

The vibrating mechanism 150 is made by fixing frame members 152, 152 to the left and right beams 143 respectively; providing electromagnet parts 153, 153 on the left and right frame members 152, 152; extending a cross-member 154 between the left and right frame members 152, 152; mounting a supporting part 155 on the cross-member 154 and disposing this supporting part 155 between the left and right fixed electromagnet parts 153, 153; mounting a slide member 156 on the supporting part 155, movably in the left-right direction; and attaching left and right moving electromagnet parts 157, 157 to the left and right ends of the slide member 156 respectively so that the left moving electromagnet part 157 is made to face the left fixed electromagnet part 153 and the right moving electromagnet part 157 is made to face the right fixed electromagnet part 153.

With this vibration-welding apparatus 140, by advancing and retracting the piston rod 148 of the air cylinder 146, it is possible to raise and lower the lower support part 149 together with the ascending/descending member 145.

And by passing current through the left and right fixed electromagnet parts 153, 153 and the moving electromagnet parts 157, 157 it is possible to vibrate the upper support part 151 together with the slide member 156 in the left-right direction.

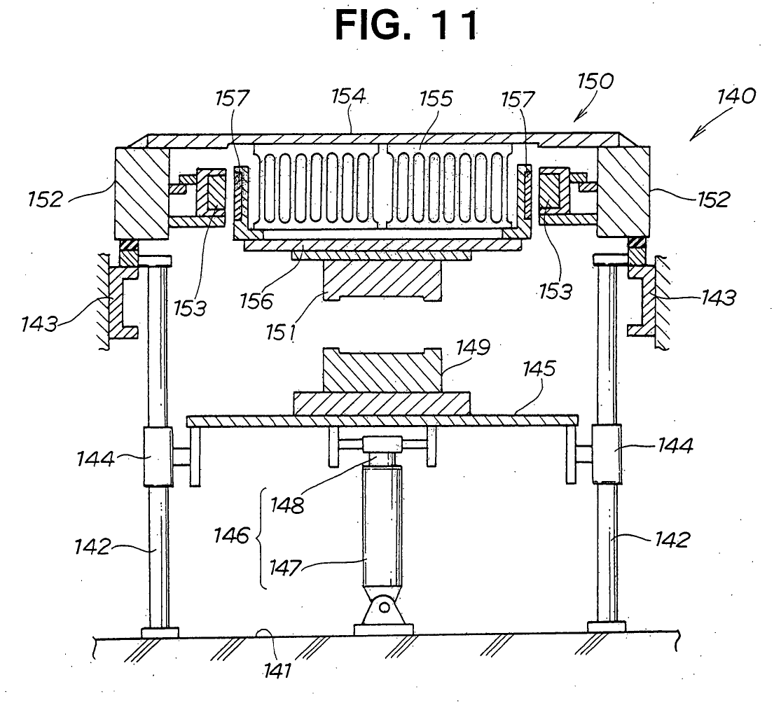

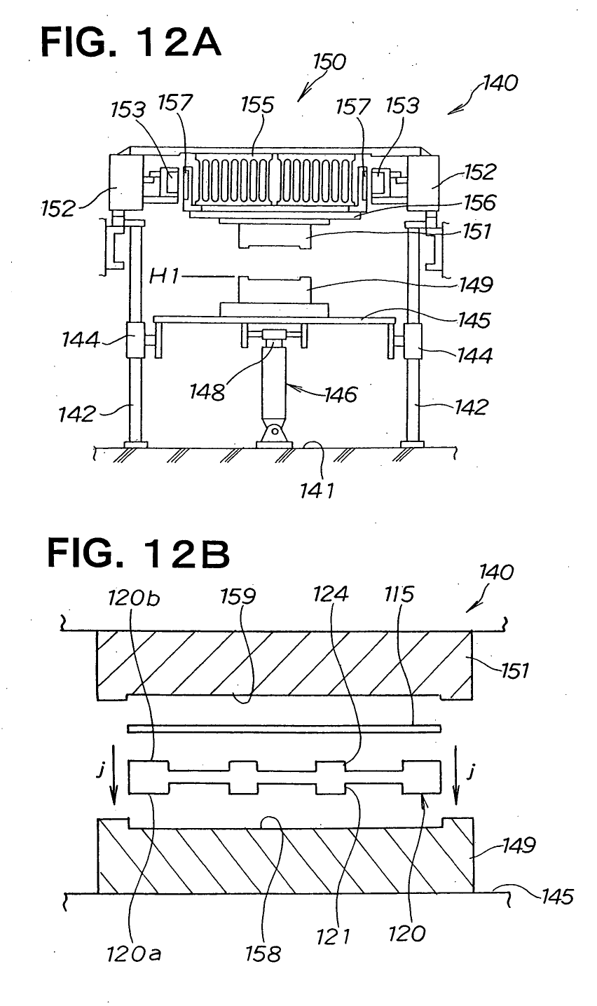

Next, with reference to FIG. 12A through FIG. 19, a method for bonding a fuel cell separator and an electrode diffusion layer according to the second embodiment will be described.

First, an example of vibration-welding the anode diffusion layer 115 to the first separator 120 will be described, on the basis of FIG. 12A through FIG. 15.

FIG. 12A and FIG. 12B are views illustrating a step of setting a first separator and an anode diffusion layer in the bonding method of the second embodiment.

In FIG. 12A, by the piston rod 148 of the air cylinder 146 provided on the vibration-welding apparatus 140 being retracted, the lower support part 149 can be lowered to a setting position H1 together with the ascending/descending member 145. By this means it is possible to move the lower support part 149 away from the upper support part 151.

In FIG. 12B, the first separator 120 and the anode diffusion layer 115 are disposed between the lower support part 149 and the upper support part 151, and the first separator 120 and the anode diffusion layer 115 are lowered toward a setting recess 158 of the lower support part 149 as shown by the arrows j.

FIG. 13A and FIG. 13B are views illustrating a step of applying a welding pressure to the first separator and the anode diffusion layer in the bonding method of the second embodiment.

In FIG. 13A, the cooling water passage formation face 120a of the first separator 120 is received in the setting recess 158 of the lower support part 149, and the anode diffusion layer 115 is laid upon and aligned with the fuel gas passage formation face 120b of the first separator 120.

Next, by the piston rod 148 of the air cylinder 146 provided on the vibration-welding apparatus 140 (see FIG. 12A) being advanced, the lower support part 149 is raised together with the ascending/descending member 145 as shown by the arrows k.

In FIG. 13B, by the lower support part 149 being raised as far as a pressing position H2, the anode diffusion layer 115 is received in a setting recess 159 of the upper support part 151 and a welding pressure F1 can be applied to the first separator 120 and the anode diffusion layer 115.

The welding pressure F1 was made for example 10 to 50 kgf/cm². The reasons for making the welding pressure F1 10 to 50 kgf/cm² are as follows.

That is, when the welding pressure F1 is less than 10 kgf/cm², it is difficult to produce sufficient frictional heat in the fuel gas passage formation face 120b of the first separator 120 and the anode diffusion layer 115, and it is not possible to weld the first separator 120 and the anode diffusion layer 115 together. So, the welding pressure F1 is set to above 10 kgf/cm² to cause the first separator 120 and the anode diffusion layer 115 to weld together.

When on the other hand the welding pressure F1 exceeds 50 kgf/cm², a large frictional heat arises in the fuel gas passage formation face 120b of the first separator 120 and the anode diffusion layer 115, the fuel gas passage formation face 120b and the anode diffusion layer 115 melt excessively, and burrs form from the edge of the first separator 120 and the edge of the anode diffusion layer 115.

Consequently, an extra step of removing burrs formed at the edge of the first separator 120 and the edge of the anode diffusion layer 115 becomes necessary. Accordingly, the welding pressure F1 is set to below 50 kgf/cm² to prevent burrs from forming at the edge of the first separator 120 and the edge of the anode diffusion layer 115.

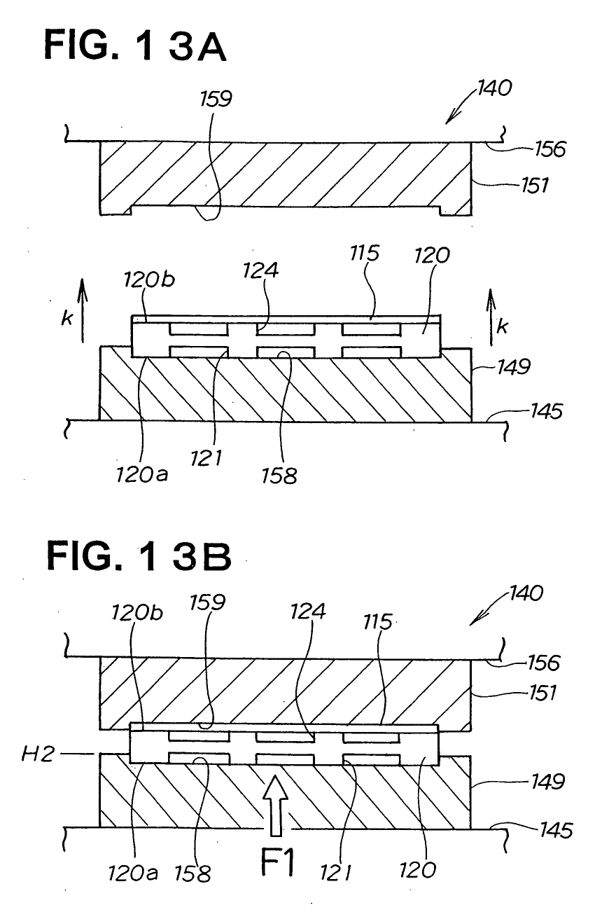

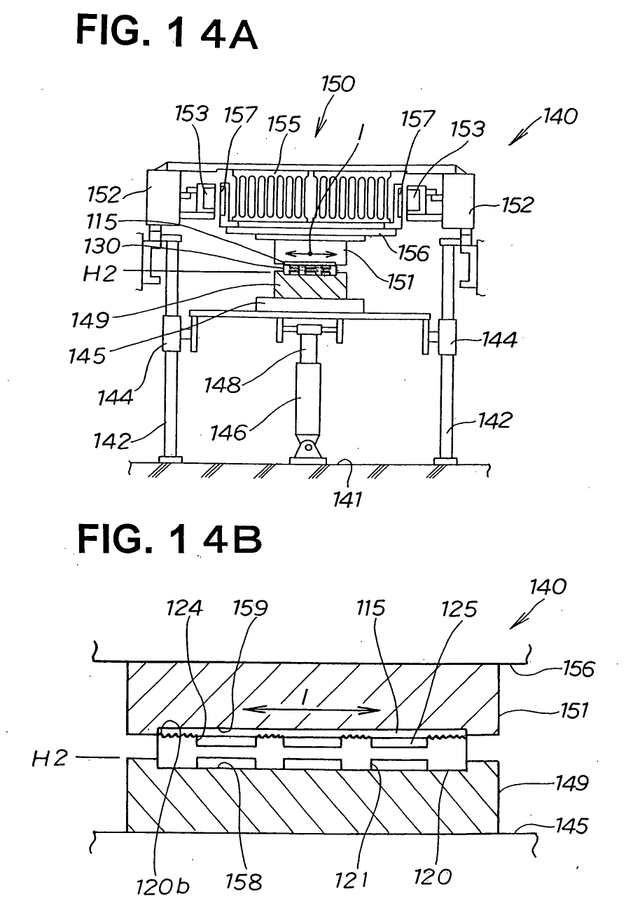

FIG. 14A and FIG. 14B are views illustrating a step of vibration-welding a first separator and an anode diffusion layer in the bonding method of the second embodiment.

In FIG. 14A, by current being passed through the left and right fixed electromagnet parts 153, 153 and the left and right moving electromagnet parts 157, 157 of the vibration-welding apparatus 140, the upper support part 151 is moved together with the slide member 156 in the left-right direction as shown by the arrow 1.

The vibration frequency (frequency) at this time is 240 Hz. The vibration frequency of 240 Hz is suitable for vibration-welding relatively small objects. Therefore, by making the vibration frequency 240 Hz, it is possible to vibration-weld the first separator 120 and the anode diffusion layer 115, which are relatively small members, well.

In FIG. 14B, by the upper support part 151 being vibrated in the left-right direction as shown by the arrow 1, the anode diffusion layer 115 is vibrated as shown by the arrow 1. As a result, frictional heat is produced in the fuel gas passage formation face 120b of the first separator 120 and the anode diffusion layer 115.

Because the first separator 120 is made of a thermoplastic resin, by frictional heat being produced in the fuel gas passage formation face 120b of the first separator 120 and the anode diffusion layer 115, the fuel gas passage formation face 120b of the first separator 120 and the anode diffusion layer 115 can be welded together.

By this means the fuel gas passage grooves 124 . . . formed in the fuel gas passage formation face 120b of the first separator 120 can be covered with the anode diffusion layer 115 to form fuel gas passages 125 . . .

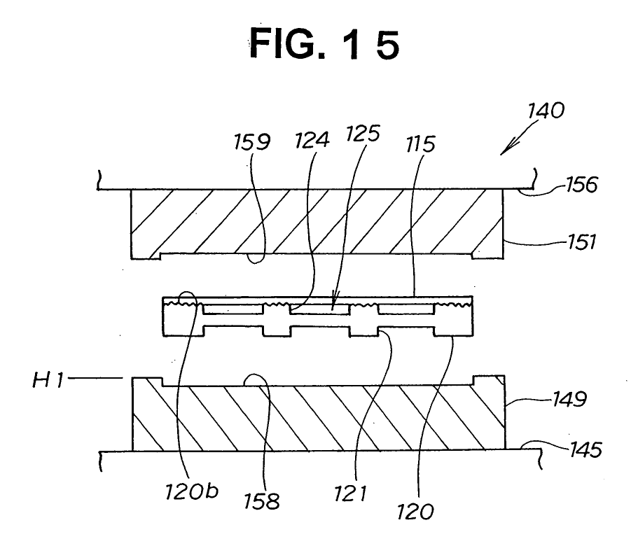

Next, referring to FIG. 15, a step of removing the vibration-welded first separator and the anode diffusion layer in the bonding method of the second embodiment will be described.

By the piston rod 148 (see FIG. 14A) of the air cylinder 146 provided on the vibration-welding apparatus 140 being retracted, the lower support part 149 is lowered together with the ascending/descending member 145.

The lower support part 149 is lowered as far as the setting position H1, the lower support part 149 is thus moved away from the upper support part 151, and the first separator 120 and the anode diffusion layer 115 integrated by vibration-welding are removed from the vibration-welding apparatus 140.

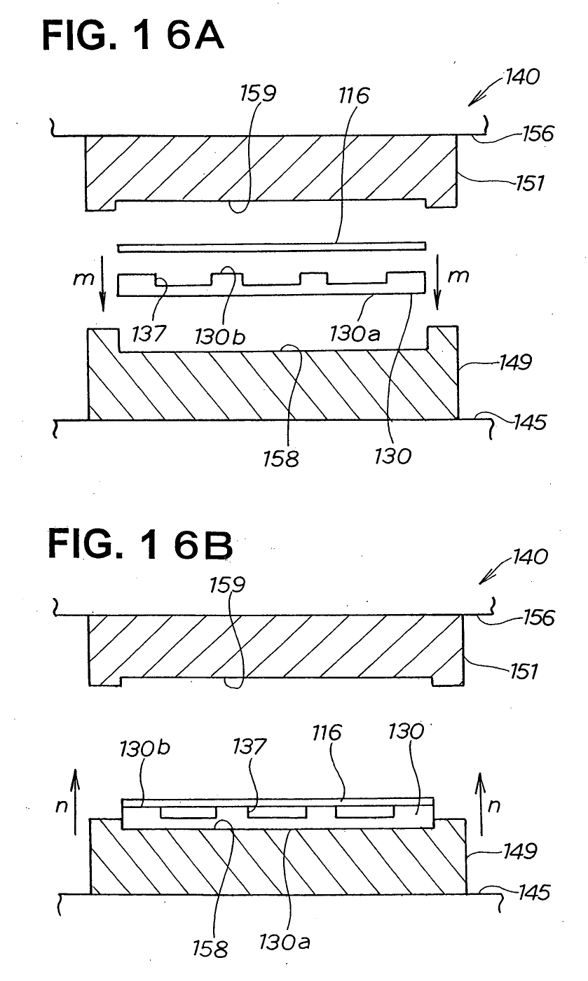

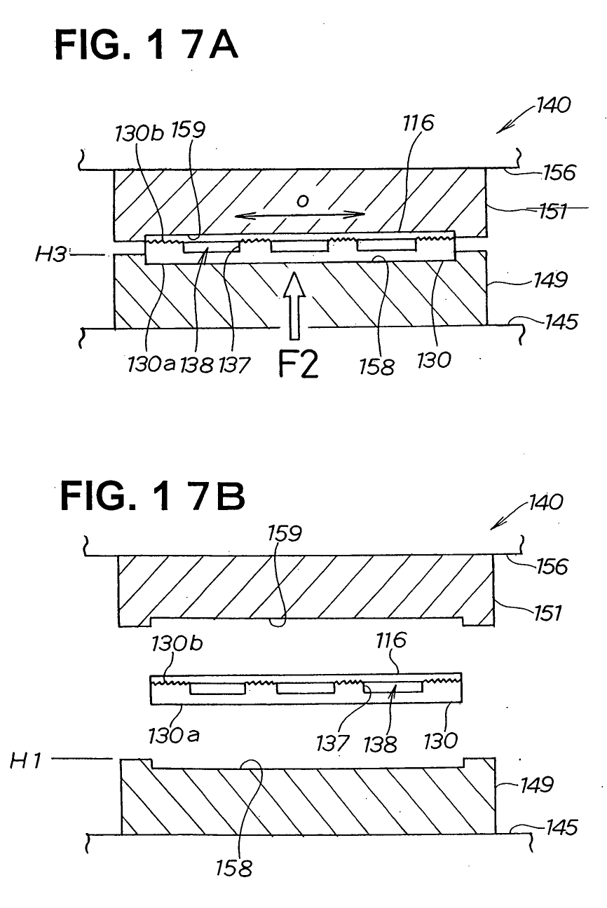

Next, an example of vibration-welding the cathode diffusion layer 116 to the second separator 130 will be described, on the basis of FIG. 16A through FIG. 17A.

FIGS. 16A and 16B are views illustrating a step of setting the second separator and the cathode diffusion layer in the bonding method according to the second embodiment.

In FIG. 16A, after the integrated first separator 120 and the anode diffusion layer 115 (see FIG. 15) are removed from the vibration-welding apparatus 140, the second separator 130 and the cathode diffusion layer 116 are disposed between the lower support part 149 and the upper support part 151 and these members 130, 116 are lowered toward the setting recess 158 of the lower support part 149 as shown by the arrows m.

In FIG. 16B, the bonding face 130a side of the second separator 130 is received in the setting recess 158 of the lower support part 149, and the cathode diffusion layer 116 is laid upon and aligned with the oxidant gas passage formation face 130b of the second separator 130.

Next, by the piston rod 148 of the air cylinder 146 provided on the vibration-welding apparatus 140 (see FIG. 12A) being advanced, the lower support part 149 is raised together with the ascending/descending member 145 as shown by the arrows n.

FIG. 17A and FIG. 17B are views illustrating a step of vibration-welding the cathode diffusion layer to the second separator in the bonding method of the second embodiment.

In FIG. 17A, by the lower support part 149 being raised as far as a pressing position H3, the cathode diffusion layer 116 is received in the setting recess 159 of the upper support part 151 and a welding pressure F2 can be applied to the second separator 130 and the cathode diffusion layer 116.

The welding pressure F2, like the welding pressure F1, was made for example 10 to 50 kgf/cm². The reasons for making the welding pressure F2 10 to 50 kgf/cm² are as explained for the welding pressure F1 of FIG. 13B.

That is, when the welding pressure F2 is less than 10 kgf/cm², it is difficult to produce sufficient frictional heat in the oxidant gas passage formation face 130b of the second separator 130 and the cathode diffusion layer 116, and it is not possible to weld the second separator 130 and the cathode diffusion layer 116 together. So, the welding force F2 is set to above 10 kgf/cm² to cause the second separator 130 and the cathode diffusion layer 116 to weld together.

When on the other hand the welding pressure F2 exceeds 50 kgf/cm², a large frictional heat arises in the oxidant gas passage formation face 130b of the second separator 130 and the cathode diffusion layer 116, the oxidant gas passage formation face 130b and the cathode diffusion layer 116 melt excessively, and burrs form from the edge of the second separator 130 and the edge of the cathode diffusion layer 116. Consequently, an extra step of removing burrs formed at the edge of the second separator 130 and the edge of the cathode diffusion layer 116 becomes necessary. Accordingly, the welding pressure F2 is set to below 50 kgf/cm² to prevent burrs from forming at the edge of the second separator 130 and the edge of the cathode diffusion layer 116.

In this state, by a current being passed through the left and right fixed electromagnet parts 153, 153 and the left and right moving electromagnet parts 157, 157 of the vibration-welding apparatus 140 shown in FIG. 12A, the upper support part 151 is vibrated together with the slide member 156 in the left-right direction as shown by the arrow o.

The vibration frequency (frequency) at this time is 240 Hz.

The reason for making the vibration frequency 240 Hz is as explained in connection with FIG. 14A. That is, the vibration frequency of 240 Hz is suitable for vibration-welding relatively small objects. Therefore, by making the vibration frequency 240 Hz, it is possible to vibration-weld the second separator 130 and the cathode diffusion layer 116, which are relatively small members, well.

By the upper support part 151 being vibrated in the left-right direction as shown by the arrow o, the cathode diffusion layer 116 is vibrated as shown by the arrow o. As a result, frictional heat is produced in the oxidant gas passage formation face 130b of the second separator 130 and the cathode diffusion layer 116.

Because the second separator 130 is made of a thermoplastic resin, by frictional heat being produced in the oxidant gas passage formation face 130b of the second separator 130 and the cathode diffusion layer 116, the oxidant gas passage formation face 130b of the second separator 130 and the cathode diffusion layer 116 can be welded together.

In this way, the oxidant gas passage grooves 137 . . . formed in the oxidant gas passage formation face 130b of the second separator 130 can be covered with the cathode diffusion layer 116 to form oxidant gas passages 138 . . .

In FIG. 17B, by the piston rod 148 (see FIG. 12A) of the air cylinder 146 provided on the vibration-welding apparatus 140 being retracted, the lower support part 149 is lowered together with the ascending/descending member 145.

By this means, the lower support part 149 is lowered to the setting position H1 and the lower support part 149 is thus moved away from the upper support part 151, and the second separator 130 and the cathode diffusion layer 116 integrated by vibration-welding are removed from the vibration-welding apparatus 140.

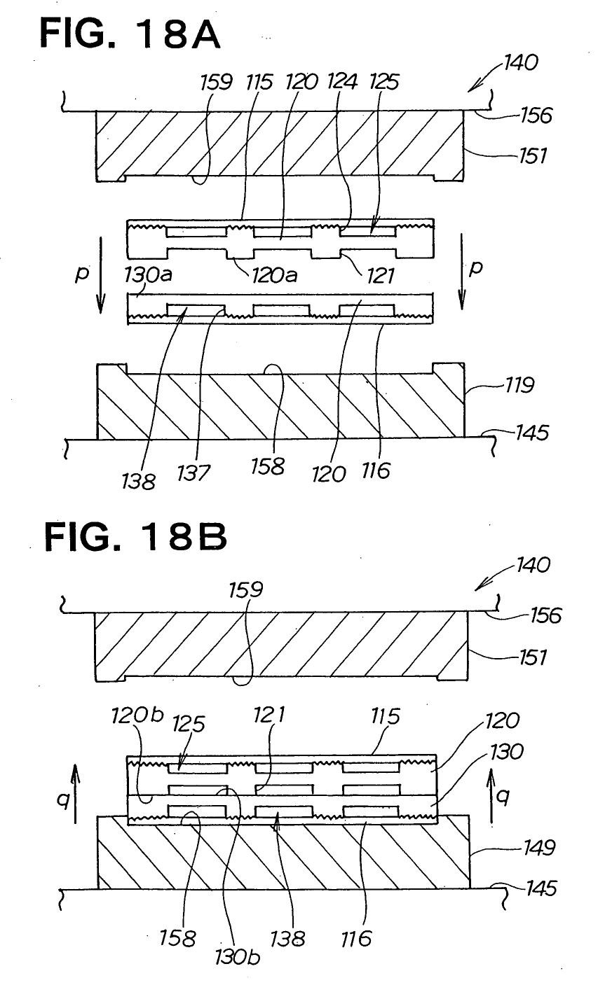

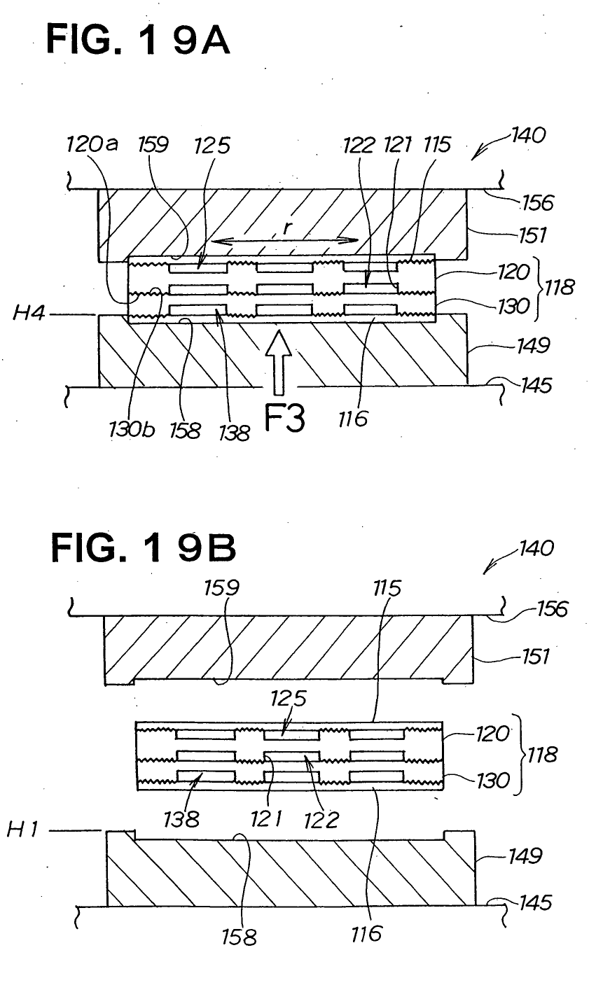

Next, with reference to FIG. 18A through FIG. 19B, the substance of vibration-welding the first and second separators together will be explained.

FIG. 18A and FIG. 18B are views illustrating the substance of setting the separators obtained in the second embodiment.

In FIG. 18A, after the second separator 130 and the cathode diffusion layer 116 integrated by vibration-welding are removed from the vibration-welding apparatus 140, the first separator 120 and the anode diffusion layer 115 integrated by vibration-welding and the second separator 130 and the cathode diffusion layer 116 integrated by vibration-welding are disposed between the lower support part 149 and the upper support part 151 and these members are lowered toward the setting recess 158 of the lower support part 149 as shown by the arrows p.

In FIG. 18B, the cathode diffusion layer 116 is received in the setting recess 158 of the lower support part 149 and the cooling water passage formation face 120a of the first separator 120 is laid upon and aligned with the bonding face 130a of the second separator 130.

Then, by the piston rod 148 of the air cylinder 146 provided on the vibration-welding apparatus 40 (see FIG. 12A) being advanced, the lower support part 149 is raised together with the ascending/descending member 145 as shown by the arrows q.

FIG. 19A and FIG. 19B are views illustrating the substance of vibration-welding separators obtained in the second embodiment together.

In FIG. 19A, by the lower support part 149 being raised to a pressing position H4, the anode diffusion layer 115 is received in the setting recess 159 of the upper support part 151 and a welding pressure F3 can be applied to the interface of the cooling water passage formation face 120a of the first separator 120 and the bonding face 130a of the second separator 130.

Here, the welding pressure F3, like the welding pressure F1, was made for example 10 to 50 kgf/cm². The reasons for making the welding pressure F3 10 to 50 kgf/cm² are as explained for the welding pressure F1.

That is, when the welding pressure F3 is less than 10 kgf/cm², it is difficult to produce sufficient frictional heat in the cooling water passage formation face 120a of the first separator 120 and the bonding face 130a of the second separator 130, and it is not possible to weld the cooling water passage formation face 120a and the bonding face 130a together.

Accordingly, the welding pressure F3 is set to above 10 kgf/cm² to cause the cooling water passage formation face 120a of the first separator 120 and the bonding face 130a of the second separator 130 to weld together.

When on the other hand the welding pressure F3 exceeds 50 kgf/cm², a large frictional heat is produced in the cooling water passage formation face 120a of the first separator 120 and the bonding face 130a of the second separator 130, and the cooling water passage formation face 120a and the bonding face 130a melt excessively, and burrs form from the edge of the first separator 120 and the edge of the second separator 130.

Consequently, an extra step of removing burrs formed at the edge of the first separator 120 and the edge of the second separator 130 becomes necessary. So, the welding pressure F3 is set to below 50 kgf/cm² to prevent burrs from forming from the edge of the first separator 120 and the edge of the second separator 130.

In this state, by a current being passed through the left and right fixed electromagnet parts 153, 153 and the left and right moving electromagnet parts 157, 157 of the vibration-welding apparatus 140 shown in FIG. 12A, the upper support part 151 is vibrated together with the slide member 156 in the left-right direction as shown by the arrow r. The vibration frequency (frequency) at this time is 240 Hz.

The reason for making the vibration frequency 240 Hz is as explained with reference to FIG. 14A. That is, the vibration frequency of 240 Hz is suitable for vibration-welding relatively small objects. Therefore, by making the vibration frequency 240 Hz, it is possible to vibration-weld the first and second separators 120, 130, which are relatively small members, well.

By the upper support part 151 being vibrated in the left-right direction as shown by the arrow r, the anode diffusion layer 115 and the first separator 120 are caused to vibrate as shown by the arrow r. As a result, frictional heat is produced in the cooling water passage formation face 120a of the first separator 120 and the bonding face 130a of the second separator 130.

Because the first and second separators 120, 130 are made of a thermoplastic resin, it is possible to form a separator 118 by producing frictional heat in the cooling water passage formation face 120a and the bonding face 130a and thereby welding together the cooling water passage formation face 120a of the first separator 120 and the bonding face 130a of the second separator 130.

At this time, the cooling water passage grooves 121 formed in the cooling water passage formation face 120a of the first separator 120 can be covered with the bonding face 130a of the second separator 130 to form the cooling water passages 122.

In FIG. 19B, by the piston rod 148 (see FIG. 12A) of the air cylinder 146 provided on the vibration-welding apparatus 140 being retracted, the lower support part 149 is lowered together with the ascending/descending member 145.

The lower support part 149 is lowered to the setting position H1, the lower support part 149 is thus moved away from the upper support part 151, and the separator 118 and the anode diffusion layer 115 and the cathode diffusion layer 116 integrated with this separator 118 by vibration-welding are removed from the vibration-welding apparatus 140. This ends the process of manufacturing a separator 118.

As described above, using the fuel cell separator manufacturing method of the second embodiment, by bringing a carbon fiber anode diffusion layer 115 together with a thermoplastic resin first separator 120 and applying a welding pressure F1 to the anode diffusion layer 115 and the first separator 120 and vibrating the anode diffusion layer 115 to produce frictional heat, it is possible to weld the anode diffusion layer 115 to the first separator 120.

And by integrating the first separator 120 and the anode diffusion layer 115 by vibration-welding, it is possible to suppress the electrical contact resistance between the first separator 120 and the anode diffusion layer 115. And, by integrating the first separator 120 and the anode diffusion layer 115 by vibration-welding, it is possible to dispense with a seal material that has been necessary in related art to join the first separator 120 with the anode diffusion layer 115. Also, by dispensing with a seal material from between the first separator 120 and the anode diffusion layer 115, it is possible to reduce the number of constituent parts. Furthermore, it is possible to reduce the assembly labor of assembling (for example, applying) a seal material between the first separator 120 and the anode diffusion layer 115.

And, by bringing a carbon fiber cathode diffusion layer 116 together with a thermoplastic resin second separator 130 and applying a welding pressure F2 to the cathode diffusion layer 116 and the second separator 130 and vibrating the cathode diffusion layer 116 to produce frictional heat, the cathode diffusion layer 116 can be welded to the second separator 130.

By integrating the second separator 130 and the cathode diffusion layer 116 by vibration-welding, it is possible to suppress the electrical contact resistance between the second separator 130 and the cathode diffusion layer 116. Also, by integrating the second separator 130 and the cathode diffusion layer 116 by vibration-welding, it is possible to dispense with a seal material that has been necessary in related art to join the second separator 130 and the cathode diffusion layer 116. And by dispensing with a seal material from between the second separator 130 and the cathode diffusion layer 116, it is possible to reduce the number of constituent parts. Furthermore, it is possible to reduce the assembly labor of assembling (for example, applying) a seal material between the second separator 130 and the cathode diffusion layer 116.

Also, by bringing together first and second thermoplastic resin separators 120, 130 and applying a welding pressure F3 to the first and second separators 120, 130 and vibrating the first separator 120 to produce frictional heat, it is possible to weld together the first and second separators 120, 130.

By integrating the first and second separators 120, 130 by vibration-welding, it is possible to suppress the electrical contact resistance between the first separator 120 and the second separator 130. And, by integrating the first and second separators 120, 130 by vibration-welding, it is possible to dispense with a seal material that has been necessary in related art to join the first and second separators 120, 130 together. Also, by dispensing with a seal material from between the first and second separators 120, 130, it is possible to reduce the number of constituent parts. Furthermore, it is possible to reduce the assembly labor of assembling (for example, applying) a seal material between the first and second separators 120, 130.

Tests were carried out in relation to the resistance over-voltage of separators (Test Examples 1 and 2) obtained by the method of the second embodiment of the invention. The results will be discussed on the basis of Table 1 and Table 2 below.

TABLE 1

| | | Comparison Example 1 | Test Example 1 |
|---|---|---|---|
| Cell Module Temp. | | 80° C. | 80° C. |
| Anode Gas | | Fuel Gas (pure H₂) | Fuel Gas (pure H₂) |
| Cathode Gas | | Oxidant Gas (air) | Oxidant Gas (air) |
| Gas Temp. | Anode | 80° C. | 80° C. |
| | Cathode | 80° C. | 80° C. |
| Gas Press. | Anode | 50 kPa | 50 kPa |
| | Cathode | 100 kPa | 100 kPa |

| | | |
|---|---|---|
| Current Density | 0.883 A/cm² | 0.883 A/cm² |

| | |
|---|---|
| Result | The resistance over-voltage of Test Example 1 |
| | was 0.014 V per cell module lower than |
| | Comparison Example 1. |

Test Example 1 was made by integrating a first separator 120 and an anode diffusion layer 115 by vibration-welding in the manner as illustrated in FIG. 12A through FIG. 15, integrating a second separator 130 and a cathode diffusion layer 116 by vibration-welding in the manner as illustrated in FIG. 16A to FIG. 17B, and interposing an ordinary seal material between the first and second separators 120, 130.

Comparison Example 1 was made by interposing an ordinary separator between a first separator 120 and an anode diffusion layer 115, interposing an ordinary separator between a second separator 130 and a cathode diffusion layer 116, and interposing an ordinary seal material between the first and second separators 120, 130.

The resistance over-voltages of Comparison Example 1 and Test Example 1 were measured under the following conditions.

That is, the temperature of the cell module was set to 80° C., pure H₂ was supplied as the anode gas (fuel gas), and air was supplied as the cathode gas (oxidant gas).

The fuel gas temperature on the anode side was made 80° C., the oxidant gas temperature on the cathode side was made 80° C., the fuel gas pressure on the anode side was made 50 kPa, and the oxidant gas pressure on the cathode side was made 100 kPa. Under these conditions, a current of current density 0.883 A/cm² was passed.

The result was that the resistance over-voltage of Test Example 1 could be reduced by 0.014V per cell module compared to the resistance over-voltage of Comparison Example 1.

Thus, it can be seen that by integrating a first separator 120 and an anode diffusion layer 115 by vibration-welding and integrating a second separator 130 and a cathode diffusion layer 116 by vibration-welding, as in Test Example 1, it is possible to reduce resistance over-voltage and prevent output drop of the fuel cell.

Reference will now be made to Table 2.

TABLE 2

| | | Comparison Example 1 | Test Example 1 |
|---|---|---|---|
| Cell Module Temp. | | 80° C. | 80° C. |
| Anode Gas | | Fuel Gas (pure H₂) | Fuel Gas (pure H₂) |
| Cathode Gas | | Oxidant Gas (air) | Oxidant Gas (air) |
| Gas Temp. | Anode | 80° C. | 80° C. |
| | Cathode | 80° C. | 80° C. |
| Gas Press. | Anode | 50 kPa | 50 kPa |
| | Cathode | 100 kPa | 100 kPa |

| | | |
|---|---|---|
| Current Density | 0.883 A/cm² | 0.883 A/cm² |

| | |
|---|---|
| Result | The resistance over-voltage of Test Example 1 |
| | was 0.014 V per cell module lower than |
| | Comparison Example 1. |

Test Example 2 was made by integrating a first separator 120 and an anode diffusion layer 115 by vibration-welding in the manner as illustrated in FIG. 12A through FIG. 15, integrating a second separator 130 and a cathode diffusion layer 116 by vibration-welding in the manner as illustrated in FIG. 16A to FIG. 17B, and integrating the first separator 120 and the second separator 130 by vibration-welding in the manner as illustrated in FIG. 18A through FIG. 19B.

Comparison Example 1 was made by, as shown in Table 1, interposing an ordinary separator between a first separator 120 and an anode diffusion layer 115, interposing an ordinary separator between a second separator 130 and a cathode diffusion layer 116, and interposing an ordinary seal material between the first and second separators 120, 130.

The resistance over-voltages of Comparison Example 1 and Test Example 2 were measured under the following conditions.

That is, the temperature of the cell module was set to 80° C., pure H₂ was supplied as the anode gas (fuel gas), and air was supplied as the cathode gas (oxidant gas).

The fuel gas temperature on the anode side was made 80° C., the oxidant gas temperature on the cathode side was made 80° C., the fuel gas pressure on the anode side was made 50 kPa, and the oxidant gas pressure on the cathode side was made 100 kPa. Under these conditions, a current of current density 0.883 A/cm² was passed.

The result was that the resistance over-voltage of Test Example 2 could be reduced by 0.041V per cell module compared to the resistance over-voltage of Comparison Example 1.

Thus, it can be seen that by integrating a first separator 120 and an anode diffusion layer 115 by vibration-welding, integrating a second separator 130 and a cathode diffusion layer 116 by vibration-welding, and integrating the first separator 120 and the second separator 130 by vibration-welding, as in Test Example 2, it is possible to reduce resistance over-voltage and prevent output drop of the fuel cell.

Next, a variation of the second embodiment of the invention will be discussed.

Although in the second embodiment an example was described wherein a first separator 120 and an anode diffusion layer 115 are welded using a vibration-welding apparatus 140 and a second separator 130 and a cathode diffusion layer 116 are welded using the vibration-welding apparatus 140 and the first and second separators 120, 130 are welded using the vibration-welding apparatus 140, there is no limitation to this, and the same effects can also be obtained by for example welding by ultrasonic welding.

Here, ultrasonic welding refers to welding utilizing vibration energy produced with an ultrasonic oscillator.

With the ultrasonic welding of this variation, after the first separator 120 and the anode diffusion layer 115 are brought together, a welding pressure is applied to the first separator 120 and the anode diffusion layer 115, and in this state vibration energy produced with an ultrasonic oscillator is applied to the first separator 120 and the anode diffusion layer 115 through a horn, and frictional heat is produced at the meeting faces of the first separator 120 and the anode diffusion layer 115, whereby the first separator 120 and the anode diffusion layer 115 can be welded together.

And, with the ultrasonic welding of the above variation, after the second separator 130 and the cathode diffusion layer 116 are brought together, a welding pressure is applied to the second separator 130 and the cathode diffusion layer 116, and in this state vibration energy produced with an ultrasonic oscillator is applied to the second separator 130 and the cathode diffusion layer 116 through a horn, and frictional heat is produced at the meeting faces of the second separator 130 and the cathode diffusion layer 116, whereby the second separator 130 and the cathode diffusion layer 116 can be welded together.

Also, with the ultrasonic welding of the above variation, after the first and second separators 120, 130 are brought together, a welding pressure is applied to the first and second separators 120, 130, and in this state vibration energy produced with an ultrasonic oscillator is applied to the first and second separators 120, 130, and frictional heat is produced at the meeting faces of the first and second separators 120, 130, whereby the first and second separators 120, 130 can be welded together.

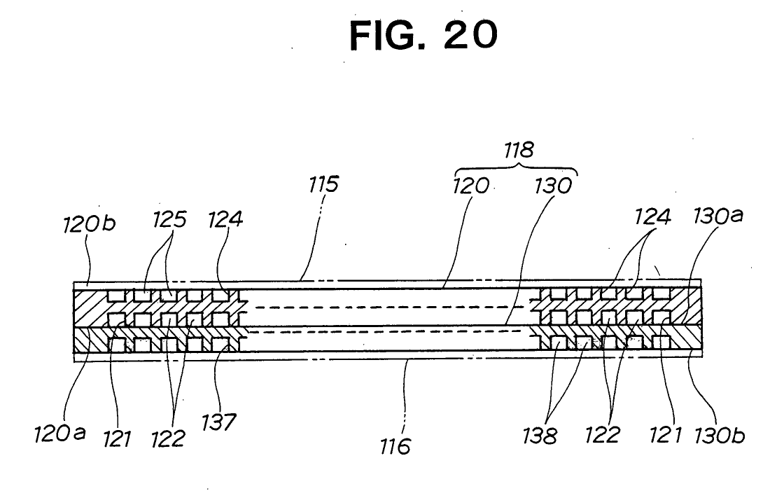

Next, with reference to FIG. 20, a fuel cell separator obtained by a fuel cell separator manufacturing method according to a third embodiment of the invention will be described. This figure differs from FIG. 10 in that the anode diffusion layer and the cathode diffusion layer are shown with broken lines.

The first separator 120, as described in connection with FIG. 10, has many fuel gas passage grooves 124 . . . in a fuel gas passage formation face 120b, and by the anode diffusion layer 115 being joined to this fuel gas passage formation face 120b, fuel gas passages 125 . . . is formed with the fuel gas passage grooves 124 . . . and the anode diffusion layer 115, and it has many cooling water passage grooves 121 . . . in the cooling water passage formation face 120a.

The second separator 130, as described in connection with FIG. 10, has many oxidant gas passage grooves 137 . . . in an oxidant gas passage formation face 130b, and by the cathode diffusion layer 116 being joined to this oxidant gas passage formation face 130b, oxidant gas passages 138 . . . are formed by the oxidant gas passage grooves 137 . . . and the cathode diffusion layer 116.

The separator 118 is made by bringing together the first and second separators 120, 130 and then applying a welding pressure to the first and second separators 120, 130 and vibrating one of the first and second separators 120, 130 to produce frictional heat, thereby vibration-welding the cooling water passage formation face 120a of the first separator 120 and the bonding face 130a of the second separator 130 together and covering the cooling water passage grooves 121 of the first separator 120 with the second separator 130 and forming cooling water passages 122.

By integrating the separator 118 by vibration-welding the first and second thermoplastic resin separators 120, 130 together and forming cooling water passages 122 by covering the cooling water passage grooves 121 in the first separator 120 with the second separator 130 like this, it is possible to dispense with a seal material that has been necessary in related art from between the first and second separators 120, 130.

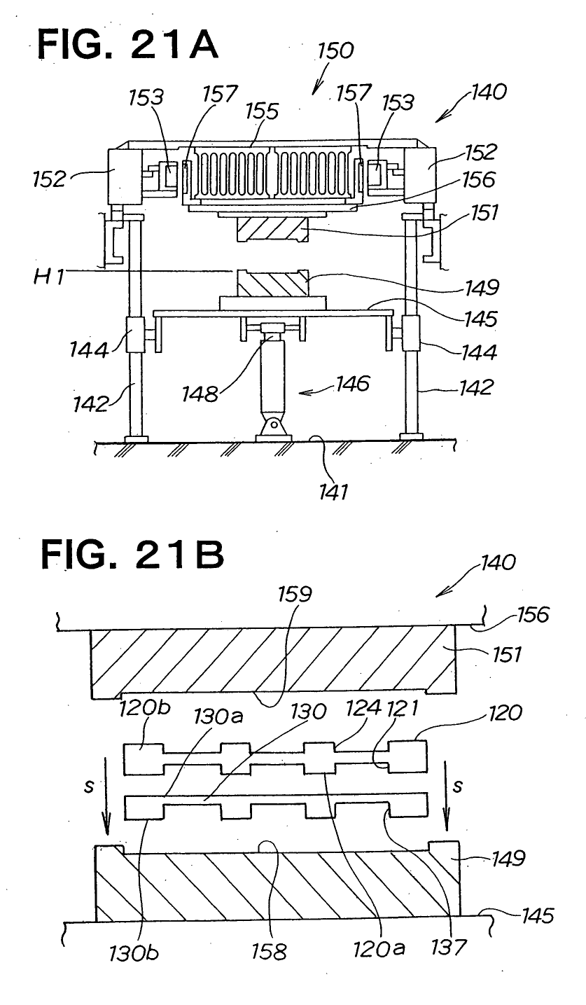

Next, a fuel cell separator manufacturing method according to the third embodiment will be described, with reference to FIG. 21A through FIG. 24.

FIG. 21A and FIG. 21B are views illustrating a step of setting first and second separators in the manufacturing method of the third embodiment.

In FIG. 21A, by the piston rod 148 of the air cylinder 146 provided on the vibration-welding apparatus 140 being retracted, the lower support part 149 is lowered together with the ascending/descending member 145 as far as the setting position H1. By this means, the lower support part 149 can be moved away from the upper support part 151.

In FIG. 21B, the first and second separators 120, 130 are disposed between the lower support part 149 and the upper support part 151, and these first and second separators 120, 130 are lowered toward the setting recess 158 of the lower support part 149 as shown by the arrows s.

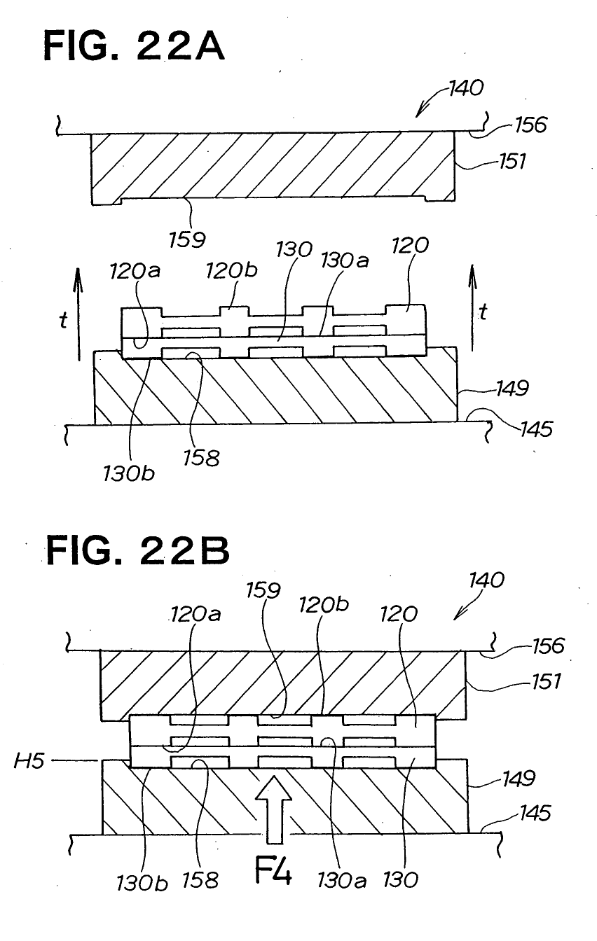

FIG. 22A and FIG. 22B are views illustrating a step of applying a welding pressure to the first and second separators in the manufacturing method of the third embodiment.

In FIG. 22A, the oxidant gas passage formation face 130b side of the second separator 130 is received in the setting recess 158 of the lower support part 149, and the cooling water passage formation face 120a of the first separator 120 is brought together with the bonding face 130a of the second separator 130.

Then, by the piston rod 148 of the air cylinder 146 provided on the vibration-welding apparatus 140 (see FIG. 21A) being advanced, the lower support part 149 is raised together with the ascending/descending member 145 as shown by the arrows t.

In FIG. 22B, by the lower support part 149 being raised as far as a pressing position H5, the fuel gas passage formation face 120b side of the first separator 120 is received in the setting recess 159 of the upper support part 151 and a welding pressure F4 can be applied to the first and second separators 120, 130.

The welding pressure F4, like the welding pressure F1, was made for example 10 to 50 kgf/cm². The reasons for making the welding pressure F4 10 to 50 kgf/cm² are as explained for the welding pressure F1 of FIG. 13B.

That is, when the welding pressure F4 is less than 10 kgf/cm², it is difficult to produce sufficient frictional heat in the cooling water passage formation face 120a of the first separator 120 and the bonding face 130a of the second separator 130, and it is not possible to weld the first and second separators 120, 130 together.

Accordingly, the welding pressure F4 is set to above 10 kgf/cm² to cause the first and second separators 120, 130 to weld together.

When on the other hand the welding pressure F4 exceeds 50 kgf/cm², a large frictional heat is produced in the cooling water passage formation face 120a of the first separator 120 and the bonding face 130a of the second separator 130, and the cooling water passage formation face 120a and the bonding face 130a melt excessively, and burrs form from the edges of the first and second separators 120, 130.

Consequently, an extra step of removing burrs formed at the edges of the first and second separators 120, 130 becomes necessary. So, the welding pressure F4 is set to below 50 kgf/cm² to prevent burrs from forming from the edges of the first and second separators 120, 130.

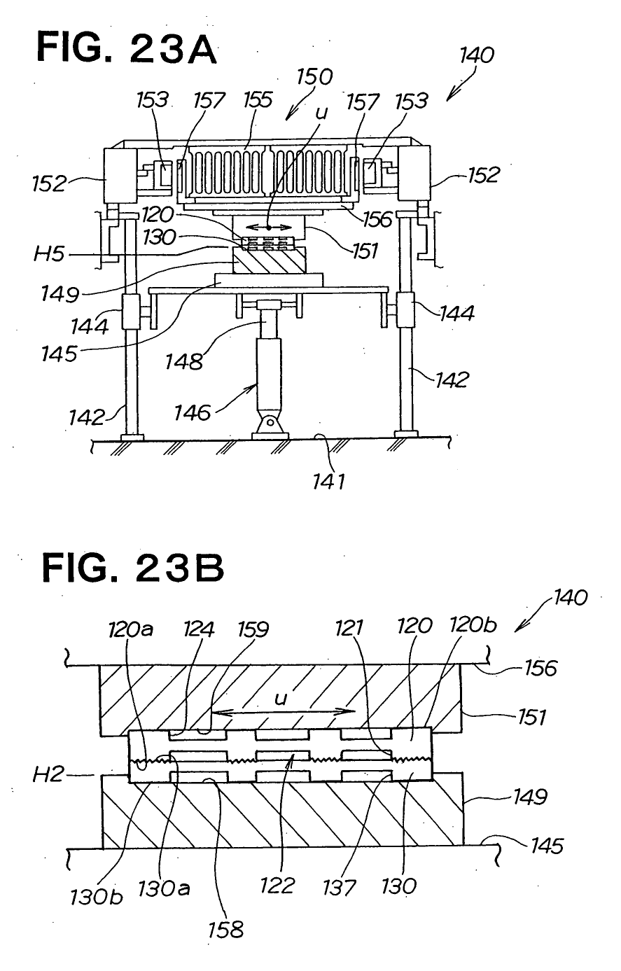

FIG. 23A and FIG. 23B are views illustrating a step of vibration-welding first and second separators together in the manufacturing method of the third embodiment.

In FIG. 23A, by a current being passed through the left and right fixed electromagnet parts 153, 153 and the left and right moving electromagnet parts 157, 157 of the vibration-welding apparatus 140, the upper support part 151 is vibrated together with the slide member 156 in the left-right direction as shown by the arrow u.

The vibration frequency (frequency) at this time is 240 Hz. The vibration frequency of 240 Hz is suitable for vibration-welding relatively small objects. Therefore, by making the vibration frequency 240 Hz, it is possible to vibration-weld the first and second separators 120, 130, which are relatively small members, well.

In FIG. 23B, by the upper support 151 being vibrated in the left-right direction as shown by the arrow u, the first separator 120 is vibrated as shown by the arrow u. By this means, frictional heat is produced in the cooling water passage formation face 120a of the first separator 120 and the bonding face 130a of the second separator 130.

Because the first and second separators 120, 130 are made of thermoplastic resin, by producing frictional heat in the cooling water passage formation face 120a of the first separator 120 and the bonding face 130a of the second separator 130 it is possible to weld the first and second separators 120, 130 together by the cooling water passage formation face 120a and the bonding face 130a.

By this means it is possible to form cooling water passages 122 . . . by covering the cooling water passage grooves 121 . . . formed in the cooling water passage formation face 120a of the first separator 120 with the bonding face 130a of the second separator 130.

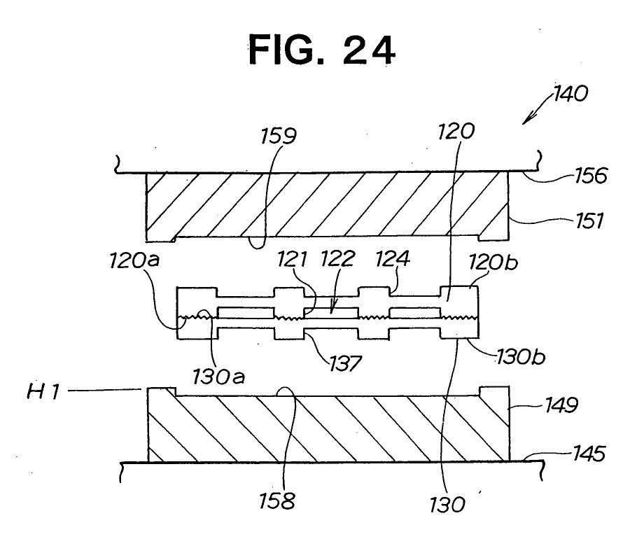

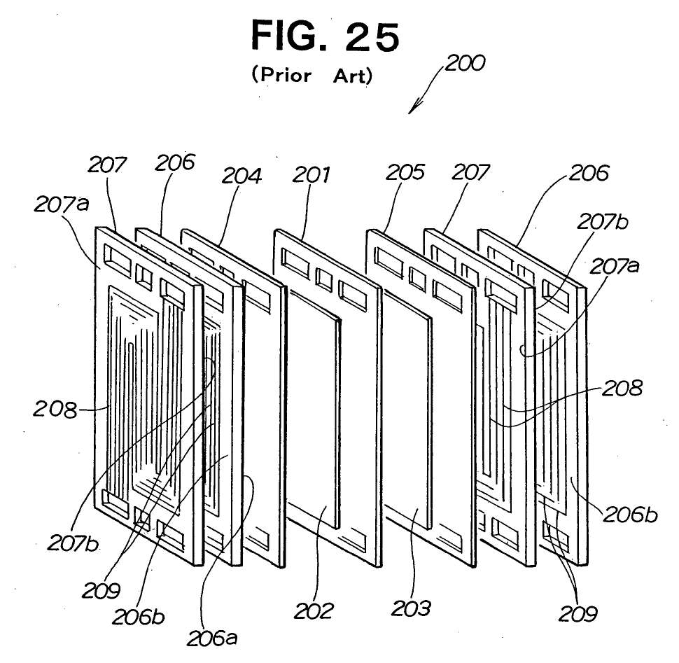

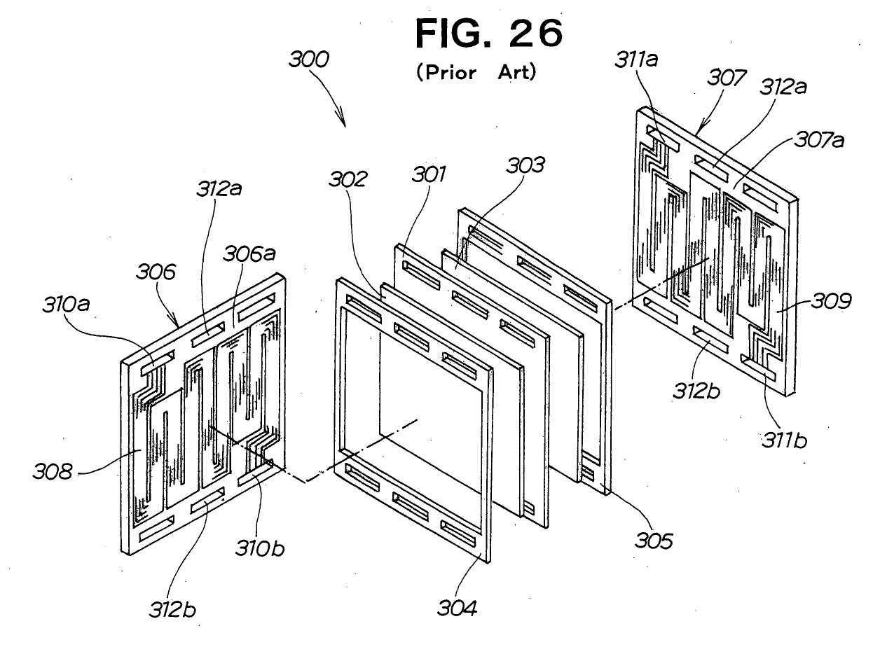

FIG. 24 is a view illustrating a step of removing the vibration-welded first and second separators in the manufacturing method of the third embodiment.

By the piston rod 148 (see FIG. 21A) of the air cylinder 146 provided on the vibration-welding apparatus 140 being retracted, the lower support part 149 is lowered together with the ascending/descending member 145.

The lower support part 149 is lowered to the setting position H1, the lower support part 149 is thus moved away from the upper support part 151, and a separator 118 consisting of the first and second separators 120, 130 integrated by vibration-welded is removed from the vibration-welding apparatus 140. This ends the process of manufacturing a separator 118.

As described above, with a fuel cell separator manufacturing method according to the third embodiment, in forming a separator 118, it is possible to integrate first and second separators 120, 130 by vibration-welding with frictional heat and form cooling water passages 122 by covering cooling water passage grooves 21 in the first separator 120 with the second separator 130.

By integrating the first and second separators 120, 130 by vibration-welding it is possible to suppress the electrical contact resistance between the first and second separators 120, 130.

And, by integrating the first and second separators 120, 130 by vibration-welding, it is possible to eliminate a seal material that has been necessary in related art from between the first and second separators 120, 130. By eliminating a seal material from between the first and second separators 120, 130 it is possible to reduce the number of constituent parts. Furthermore, it is possible to reduce the assembly labor of assembling (for example, applying) a seal material between the first and second separators 120, 130.

The resistance over-voltage of a separator 118 obtained by the method of the third embodiment (see FIG. 20; Test Example 3) was tested. The results will be discussed on the basis of Table 3 below.

TABLE 3

| | | Comparison Example 1 | Test Example 1 |
|---|---|---|---|
| Cell Module Temp. | | 80° C. | 80° C. |
| Anode Gas | | Fuel Gas (pure H₂) | Fuel Gas (pure H₂) |
| Cathode Gas | | Oxidant Gas (air) | Oxidant Gas (air) |
| Gas Temp. | Anode | 80° C. | 80° C. |
| | Cathode | 80° C. | 80° C. |
| Gas Press. | Anode | 50 kPa | 50 kPa |
| | Cathode | 100 kPa | 100 kPa |

| | | |
|---|---|---|
| Current Density | 0.883 A/cm² | 0.883 A/cm² |

| | |
|---|---|
| Result | The resistance over-voltage of Test Example 1 |
| | was 0.014 V per cell module lower than |
| | Comparison Example 1. |

Comparison Example 2 is a separator wherein a first separator and a second separator are not vibration-welded but are bonded with a seal material.

Test Example 3 is the separator 118 of the third embodiment, wherein a first separator 120 and a second separator 130 are vibration-welded together.

The resistance over-voltage of Comparison Example 2 and Test Example 3 were measured under the following conditions.

That is, the temperature of the cell module was set to 80° C., pure H₂ was supplied as the anode gas (fuel gas), and air was supplied as the cathode gas (oxidant gas).

The fuel gas temperature on the anode side was made 80° C., the oxidant gas temperature on the cathode side was made 80° C., the fuel gas pressure on the anode side was made 50 kPa, and the oxidant gas pressure on the cathode side was made 100 kPa. Under these conditions, a current of current density 0.883 A/cm² was passed.

The result was that the resistance over-voltage of Test Example 3 could be reduced by 0.027V per cell module compared to the resistance over-voltage of Comparison Example 2.

Thus, it can be seen that by vibration-welding the first separator 120 and the second separator 130 together, as in Test Example 3, it is possible to reduce resistance over-voltage and prevent output drop of the fuel cell.

Next, a variation of the manufacturing method of the third embodiment will be described.

Although in the manufacturing method of the third embodiment an example was described wherein the first and second separators 120, 130 were welded using a vibration-welding apparatus 140, there is no limitation to this, and the same effects can also be obtained by for example welding the first and second separators 120, 130 by ultrasonic welding.

Here, ultrasonic welding refers to welding utilizing vibration energy produced with an ultrasonic oscillator.

With the ultrasonic welding of this variation, after the first and second separators 120, 130 are brought together, a welding pressure is applied to the first and second separators 120, 130, in this state vibration energy produced with an ultrasonic oscillator is applied to the first and second separators 120, 130 through a horn, and frictional heat is produced at the meeting faces of the first and second separators 120, 130, whereby the first and second separators 120, 130 can be welded together.

With the ultrasonic welding of this variation, as in the vibration-welding of the manufacturing method of the third embodiment, by welding the first and second separators 120, 130 together it is possible to form cooling water passages 122 by covering the cooling water passage grooves 121 formed in the first separator 120 with the second separator 130.

Although in the embodiments described above solid polymer electrolyte type fuel cells 10, 110 were described wherein a solid polymer electrolyte was used as the electrolyte membrane 12, 112, there is no limitation to this, and the invention can also be applied to other fuel cells.

And although in the method of the first embodiment an example was described wherein first and second separators 20, 30 were formed continuously by extrusion-molding or press-forming, there is no limitation to this, and it is also possible to mold them by some other manufacturing method such as thermal pressing, injection molding or transfer molding.

Transfer molding is a method of molding by putting one shot of a molding material into a pot part other than the cavity and then transferring the molten material into the cavity with a plunger.

Also, although in the method of the first embodiment an example was described wherein first and second separators 20, 30 were bonded by vibration-welding, there is no limitation to this, and it is also possible to bring together the first and second separators 20, 30 and seal the cooling water passage formation face 20a and the bonding face 30a well by irradiating the cooling water passage formation face 20a of the first separator 20 with an electron beam and irradiating the bonding face 30a of the second separator 30 with an electron beam to raise the elasticity of the cooling water passage formation face 20a and the bonding face 30a.

And, although in the methods of the second and third embodiments examples were described wherein in the welding of the anode diffusion layer 115 to the first separator 120 the anode diffusion layer 115 is vibrated, the same effects can be obtained by vibrating the first separator 120 instead of the anode diffusion layer 115.

Also, although in the methods of the second and third embodiments examples were described wherein in the welding of the cathode diffusion layer 116 of the second separator 130 the cathode diffusion layer 116 is vibrated, the same effects can be obtained by vibrating the second separator 130 instead of the cathode diffusion layer 116.

Furthermore, although in the methods of the second and third embodiments examples were described wherein in the welding together of the first and second separators 120, 130 the first separator 120 was vibrated, the same effects can be obtained by vibrating the second separator 130 instead of the first separator 120.

And, although in the methods of the second and third embodiments examples were described wherein cooling water passage grooves 121 were formed in the first separator 120 and the bonding face 130a of the second separator 130 was made a flat face, it is also possible to make the first separator 120 a flat face and form cooling water passage grooves in the second separator 130.

Furthermore, it is also possible to form cooling water passage grooves in each of the first and second separators 120, 130 and by vibration-welding the first and second separators 120, 130 form cooling water passages with the cooling water passage grooves in each.

### INDUSTRIAL APPLICABILITY

As explained above, with the present invention, by mixing a thermoplastic resin and a conductive material into a mixture, forming a separator starting material having gas flow passage grooves in a contact face to contact a diffusion layer with this mixture, and irradiating the contact face of this separator starting material with an electron beam, it is possible to eliminate the time and labor of applying seal members. Accordingly, because it is possible to raise productivity and also suppress costs, for example the invention can be used effectively by being applied to relatively mass-produced goods such as fuel cells of automotive vehicles.

1. A method for manufacturing a fuel cell separator, comprising the steps of:
obtaining a mixture by mixing a thermoplastic resin and a conductive material, wherein the thermoplastic resin is a resin selected from the group consisting of: ethylene/vinyl acetate copolymers, ethylene/ethyl acrylate copolymers, straight-chain low-density polyethylene, polyphenylene sulfide and modified polyphenylene oxide, and wherein the conductive material includes carbon particles selected from the group consisting of black lead, Ketchen black and acetylene black;
forming with the mixture a separator starting material having gas flow passage grooves in a contact face thereof; and
irradiating the contact face of the separator starting material with an electron beam.

2. (canceled)

3. A method for bonding a fuel cell separator and an electrode diffusion layer to one another, comprising the steps of:
disposing a carbon fiber electrode diffusion layer on a thermoplastic resin separator;
applying a welding pressure to the electrode diffusion layer and separator; and
vibrating at least one of the electrode diffusion layer and the separator to produce frictional heat between said electrode diffusion layer and said separator and thereby welding the electrode diffusion layer to the separator.

4. The method for bonding a fuel cell separator and an electrode diffusion layer according to claim 3, comprising the further step of setting the welding pressure to between about 10 to 50 kgf/cm² (about 980 to 4903 kPa).

5. A method for manufacturing a fuel cell separator, comprising:
preparing a first separator and a second separator, each of said first and second separators being made of thermoplastic resin at least one of said first and second separators having cooling water passage grooves formed therein;
bringing the first and second separators together such that the cooling water passage grooves formed in said at least one of the first and second separators is covered by the other of said first and second separators;
applying a welding pressure to the first and second separators;
vibrating one of the first and second separators to produce frictional heat between the first and second separators and thereby welding the second separator to the first separator so as to form cooling water passages between said first and second separators.

6. The fuel cell separator manufacturing method according to claim 5, comprising the further step of setting the welding pressure to between about 10 to 50 kgf/cm² (about 980 to 4903 kPa).

7. The method for bonding a fuel cell separator and an electrode diffusion layer according to claim 4, comprising the further step of setting a vibration frequency to about 240 Hz.

8. The fuel cell separator manufacturing method according to claim 6, comprising the further step of setting a vibration frequency to about 240 Hz.
